(19) United States
(12) Patent Application Publication
(10) Pub. No.: US 2013/0224425 A1
(43) Pub. Date: Aug. 29, 2013

(54) PRESSURE-SENSITIVE ADHESIVE SHEET FOR IMAGE DISPLAY DEVICE, METHOD FOR PRODUCING IMAGE DISPLAY DEVICE AND IMAGE DISPLAY DEVICE

(71) Applicants: Kouji YAMAZAKI, Chikusei-shi (JP); Kenichi SHINYA, Chikusei-shi (JP); Tomoyuki NAKAMURA, Chikusei-shi (JP); Satoshi OHKAWA, Chikusei-shi (JP); Junichi IMAIZUMI, Chikusei-shi (JP); Hiroaki TAKAHASHI, Chikusei-shi (JP)

(72) Inventors: Kouji YAMAZAKI, Chikusei-shi (JP); Kenichi SHINYA, Chikusei-shi (JP); Tomoyuki NAKAMURA, Chikusei-shi (JP); Satoshi OHKAWA, Chikusei-shi (JP); Junichi IMAIZUMI, Chikusei-shi (JP); Hiroaki TAKAHASHI, Chikusei-shi (JP)

(73) Assignee: HITACHI CHEMICAL COMPANY, LTD., Tokyo (JP)

(21) Appl. No.: 13/773,766

(22) Filed: Feb. 22, 2013

Related U.S. Application Data
(60) Provisional application No. 61/602,097, filed on Feb. 23, 2012.

(30) Foreign Application Priority Data
Apr. 27, 2012 (JP) P2012-102990

(51) Int. Cl. C09J 7/02; B32B 37/02

(52) U.S. Cl. CPC C09J 7/0207; B32B 37/02
USPC 428/78; 156/273.7; 428/523

(57) ABSTRACT

A pressure-sensitive adhesive sheet 1 for an image display device, comprising a film-shaped pressure-sensitive adhesive layer 2 and a pair of base material layers 3 and 4 laminated so as to sandwich the adhesive layer 2, wherein outer edges 3a and 4a of the base material layers 3 and 4 project more outward than an outer edge 2a of the pressure-sensitive adhesive layer 2, and the pressure-sensitive adhesive layer 2 is formed from a pressure-sensitive adhesive resin composition comprising a structural unit derived from an alkyl (meth)acrylate in which the number of carbon atoms of an alkyl group is 4 to 18, and has a shear storage modulus at 25° C. of 30 to 150 kPa.

### BACKGROUND OF THE INVENTION

1. Field of the Invention

The present invention relates to a pressure-sensitive adhesive sheet for an image display device, a method for producing an image display device, and an image display device.

2. Related Background Art

In recent years, a method has been proposed in which a gap between a transparent protective plate or an information input device (for example, a touch panel or the like) and the display surface of an image display unit in an image display device, or a gap between the transparent protective plate and the information input device, is replaced by a transparent material in which a refractive index is closer to that of the transparent protective plate, the information input device, and the display surface of the image display unit than that of air, to improve transmissiveness and suppress a decrease in the brightness and contrast of the image display device (for example, Japanese Patent Application Laid-Open No. 2008-83491). An example of a schematic view of a liquid crystal display device as an example of an image display device is shown in FIG. 1. The liquid crystal display device having a touch panel built therein is composed of a transparent protective plate (glass or plastic substrate) D1, a touch panel D2, a polarizing plate D3, and a liquid crystal display cell D4, and for the prevention of cracks, the relaxation of stress and impact, and the improvement of visibility in the liquid crystal display device, a pressure-sensitive adhesive layer D5 is provided between the transparent protective plate and the touch panel, and a pressure-sensitive adhesive layer D6 may be further provided between the touch panel and the polarizing plate.

It is necessary to provide input and output wiring in the peripheral edge portions of the information input device and the image display unit, and generally, a frame-shaped decorative portion is provided (19 (frame pattern) in FIG. 1 in Japanese Patent Application Laid-Open No. 2008-83491, or the like) in the peripheral edge portion of the transparent protective plate by printing or the like so that the wiring cannot be seen from a transparent protective plate surface side. In order to eliminate a step formed by the decorative portion, for example, a film-shaped pressure-sensitive adhesive may be used as a pressure-sensitive adhesive for bonding the transparent protective plate, but in order to fill up the vicinity of this step without clearance, excellent step height covering properties is required of the film-shaped pressure-sensitive adhesive. In recent years, various film-shaped pressure-sensitive adhesives for improving such step height covering properties have been studied (for example, Japanese Patent Application Laid-Open No. 2011-74308).

### SUMMARY OF THE INVENTION

However, in the film-shaped pressure-sensitive adhesive described in Japanese Patent Application Laid-Open No. 2011-74308, though step height covering properties can be improved to some extent, the step height covering properties cannot be said to be sufficient yet.

On the other hand, such a film-shaped pressure-sensitive adhesive may be handled as a pressure-sensitive adhesive sheet in a state in which both surfaces of a pressure-sensitive adhesive layer (film-shaped pressure-sensitive adhesive) are sandwiched between peelable base materials, in order to prevent dust and the like from attaching during storage and transport. At this time, it is preferred that the pressure-sensitive adhesive layer is formed into the size of a corresponding image display device. Generally, a pressure-sensitive adhesive layer is cut, including base materials, in order to be formed into a desired shape, and therefore, there is a pressure-sensitive adhesive sheet in which the outer edge of a pressure-sensitive adhesive layer aligns with the outer edge of base materials, and in this case, a problem is that dust and the like easily attach to the cut surfaces of the pressure-sensitive adhesive layer, or it is difficult to strip the base materials from the pressure-sensitive adhesive layer and the pressure-sensitive adhesive sheet is poor in handling. Therefore, it is preferred that the outer edge of at least one base material projects more outward than the outer edge of the pressure-sensitive adhesive layer. As a method for fabricating a pressure-sensitive adhesive sheet having such a structure, for example, forming a pressure-sensitive adhesive layer on one base material and then cutting only the pressure-sensitive adhesive layer without cutting the one base material are considered. At this time, in order to cut the pressure-sensitive adhesive layer, generally, it is effective to cut the pressure-sensitive adhesive by blades or the like, but in such a film-shaped pressure-sensitive adhesive, due to its properties, it is difficult to obtain good cutting properties, which may be a factor that decreases workability.

The present invention has been made in view of the above circumstances, and it is an object of the present invention to provide a pressure-sensitive adhesive sheet for an image display device that is excellent in the filling-up properties of a step formed on an adherend, comprises a pressure-sensitive adhesive layer that can be easily cut into a desired shape, and is also excellent in handling properties. In addition, it is an object of the present invention to provide a method for producing an image display device using the pressure-sensitive adhesive sheet for an image display device, and an image display device.

The present inventors have studied diligently in order to solve the above problems, and, as a result, found that a pressure-sensitive adhesive sheet comprising a pressure-sensitive adhesive layer that is formed from a pressure-sensitive adhesive resin composition comprising a structural unit derived from an alkyl (meth)acrylate in which the number of carbon atoms of an alkyl group is 4 to 18, and has particular physical properties can solve the above problems. The present invention has been completed based on such findings.

Specifically, the present invention provides a pressure-sensitive adhesive sheet for an image display device, comprising a pressure-sensitive adhesive layer and a pair of base material layers laminated so as to sandwich the pressure-sensitive adhesive layer, wherein outer edges of the base material layers project more outward than an outer edge of the pressure-sensitive adhesive layer, and the pressure-sensitive adhesive layer is formed from a pressure-sensitive adhesive resin composition comprising a structural unit derived from an alkyl (meth)acrylate in which a number of carbon atoms of an alkyl group is 4 to 18, and has a shear storage modulus at 25° C. of 30 to 150 kPa.

According to such a pressure-sensitive adhesive sheet for an image display device (hereinafter sometimes simply referred to as an “adhesive sheet”), the respective outer edges of the base material layers project more outward than the outer edge of the pressure-sensitive adhesive layer, and therefore, the outer edge portion of the pressure-sensitive adhesive layer is reliably protected in the storage, transport, and the like of the pressure-sensitive adhesive sheet. In addition, when the pressure-sensitive adhesive layer is affixed to adherends, each base material layer can be easily peeled by pinching the outer edge portion of the base material layer projecting outward. By peeling each base material layer and affixing the pressure-sensitive adhesive layer to the adherends, the pressure-sensitive adhesive layer can be disposed between the pair of adherends.

The present invention also provides a pressure-sensitive adhesive sheet for an image display device, comprising a pressure-sensitive adhesive layer, first and second base material layers laminated so as to sandwich the pressure-sensitive adhesive layer, and a carrier layer further laminated on the second base material layer, wherein outer edges of the first base material layer and the carrier layer project more outward than an outer edge of the pressure-sensitive adhesive layer, and the pressure-sensitive adhesive layer is formed from a pressure-sensitive adhesive resin composition comprising a structural unit derived from an alkyl (meth)acrylate in which a number of carbon atoms of an alkyl group is 4 to 18, and has a shear storage modulus at 25° C. of 30 to 150 kPa.

According to such a pressure-sensitive adhesive sheet, the outer edges of the first base material layer and the carrier layer forming outer layers project more outward than the outer edge of the pressure-sensitive adhesive layer forming an inner layer. Thus, the outer edge portion of the pressure-sensitive adhesive layer is reliably protected in the storage, transport, and the like of the pressure-sensitive adhesive sheet. In addition, when the pressure-sensitive adhesive layer is affixed to adherends, the carrier layer can be easily peeled from the second base material layer by pinching the outer edge portion of the carrier layer projecting outward. Next, the first base material layer can be easily peeled by pinching the outer edge portion of the first base material layer. At this time, the second base material layer remains on one side of the pressure-sensitive adhesive layer, and therefore, when one surface of the pressure-sensitive adhesive layer is affixed to an adherend, the protection of the pressure-sensitive adhesive layer by this second base material layer is maintained. Then, by peeling the second base material layer and affixing the other surface of the pressure-sensitive adhesive layer to another adherend, the pressure-sensitive adhesive layer can be disposed between the pair of adherends.

These pressure-sensitive adhesive sheets can be fabricated only after the pressure-sensitive adhesive layer can be preferably cut to a predetermined size during the fabrication of the pressure-sensitive adhesive sheet. In the present invention, by forming the pressure-sensitive adhesive layer from a pressure-sensitive adhesive resin composition comprising a structural unit derived from an alkyl (meth)acrylate in which the number of carbon atoms of an alkyl group is 4 to 18, and further adjusting the shear storage modulus of the pressure-sensitive adhesive layer at 25° C. in the range of 30 to 150 kPa, preferred cutting properties and step height covering properties of the pressure-sensitive adhesive layer are achieved.

The present invention further provides a method for producing an image display device, comprising a step of bonding adherends to each other via the pressure-sensitive adhesive layer that the above pressure-sensitive adhesive sheet comprises, to obtain a laminate; a step of subjecting the laminate to heating and pressurization treatment under conditions of 40 to 80° C. and 0.3 to 0.8 MPa; and a step of irradiating the laminate with ultraviolet rays from a side of either one of the adherends.

By using the pressure-sensitive adhesive sheet of the present invention, an image display unit and other members (adherends) considered necessary for an image display device, for example, an image display unit, such as an liquid crystal display unit, and a touch panel, the image display unit and a transparent protective plate, or the touch panel and the transparent protective plate, can be bonded to each other. The present invention can be preferably used particularly when the adherends are a transparent protective plate and a touch panel. Similarly, by using the pressure-sensitive adhesive sheet of the present invention, members that are on the visible side of the image display unit of an image display device can also be bonded to each other. At this time, for example, even if a transparent protective plate on the visible side has a step along its outer peripheral edge, visibility is not decreased because the step is reliably filled up by the pressure-sensitive adhesive layer.

In addition, the present invention provides an image display device produced by the above method. An image display device fabricated using the pressure-sensitive adhesive sheet of the present invention has both excellent impact resistance and visibility.

According to the present invention, it is possible to provide a pressure-sensitive adhesive sheet for an image display device that is excellent in the filling-up properties of a step formed on an adherend, comprises a pressure-sensitive adhesive layer that can be easily cut into a desired shape, and is also excellent in handling properties. In addition, the present invention can provide a method for producing an image display device using such a pressure-sensitive adhesive sheet, and an image display device.

### BRIEF DESCRIPTION OF THE DRAWINGS

FIG. 1 is a cross-sectional view showing one embodiment of an image display device;

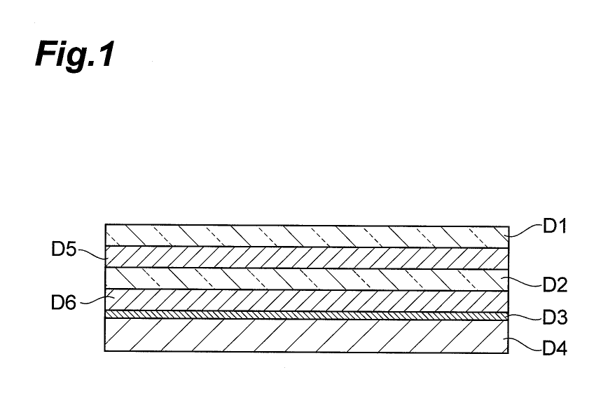

FIG. 2 is a perspective view showing one embodiment of a pressure-sensitive adhesive sheet according to the present invention;

FIG. 3 is a cross-sectional view showing one embodiment of the pressure-sensitive adhesive sheet according to the present invention;

FIG. 4 is a cross-sectional view of a matrix film;

FIG. 5 is a cross-sectional view showing a cutting step;

FIG. 6 is a cross-sectional view showing a removal step;

FIG. 7 is a cross-sectional view showing a removal step;

FIG. 8 is a cross-sectional view showing an affixation step;

FIG. 9 is a cross-sectional view showing one embodiment of an image display device;

FIG. 10 is a cross-sectional view showing one embodiment of an image display device;

FIG. 11 is a cross-sectional view showing the step of peeling a light release separator;

FIG. 12 is a cross-sectional view showing the step of affixing a pressure-sensitive adhesive surface to an adherend;

FIG. 13 is a cross-sectional view showing the step of peeling a heavy release separator;

FIG. 14 is a cross-sectional view showing the step of affixing a pressure-sensitive adhesive surface to an adherend;

FIG. 15 is a perspective view showing one embodiment of the pressure-sensitive adhesive sheet according to the present invention;

FIG. 16 is a side view showing one embodiment of the pressure-sensitive adhesive sheet according to the present invention;

FIG. 17 is a cross-sectional view of a matrix film;

FIG. 18 is a cross-sectional view showing a cutting step;

FIG. 19 is a cross-sectional view showing a removal step;

FIG. 20 is a cross-sectional view showing a removal step;

FIG. 21 is a cross-sectional view showing a removal step;

FIG. 22 is a cross-sectional view showing an affixation step;

FIG. 23 is a cross-sectional view showing the step of peeling a carrier film; and

FIG. 24 is a schematic view showing a method for measuring a sample using a wide area dynamic viscoelasticity measuring device.

### DESCRIPTION OF THE PREFERRED EMBODIMENTS

The preferred embodiments (first embodiment and second embodiment) of the present invention will be described below, but the present invention is not limited to these embodiments in any way. Descriptions overlapping between both embodiments will be described only in the first embodiment, and appropriately omitted in the second embodiment. In addition, “(meth)acrylate” means “acrylate” and “methacrylate” corresponding to the “acrylate” herein. Similarly, “(meth)acrylic” means “acrylic” and “methacrylic” corresponding to the “acrylic,” and “(meth)acryloyl” means “acryloyl” and “methacryloyl” corresponding to the “acryloyl.”

### First Embodiment

### Pressure-sensitive Adhesive Sheet for Image Display Device

A pressure-sensitive adhesive sheet for an image display device in this embodiment comprises a pressure-sensitive adhesive layer and a pair of base material layers laminated so as to sandwich the pressure-sensitive adhesive layer, and the outer edges of the base material layers project more outward than the outer edge of the pressure-sensitive adhesive layer.

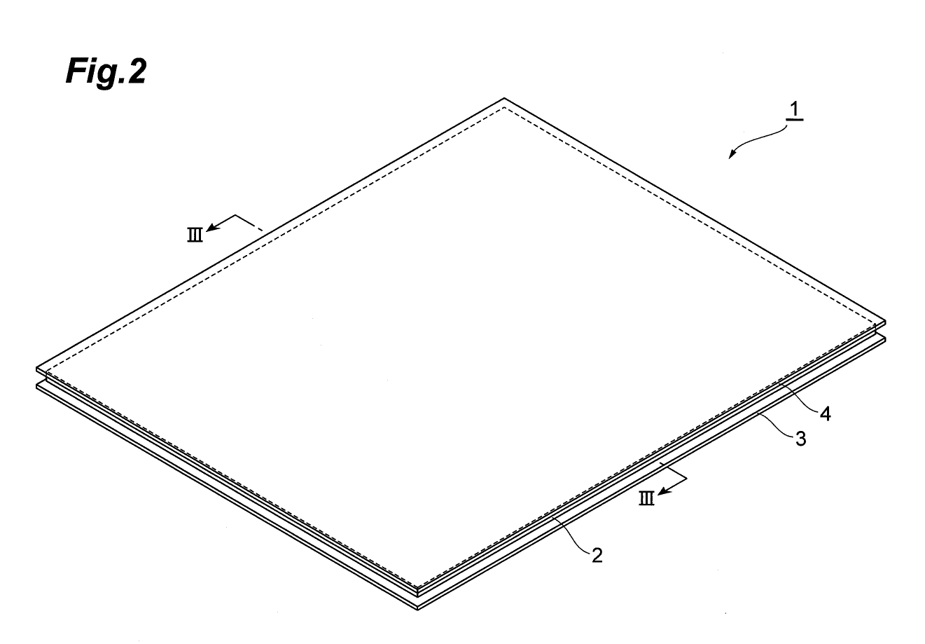

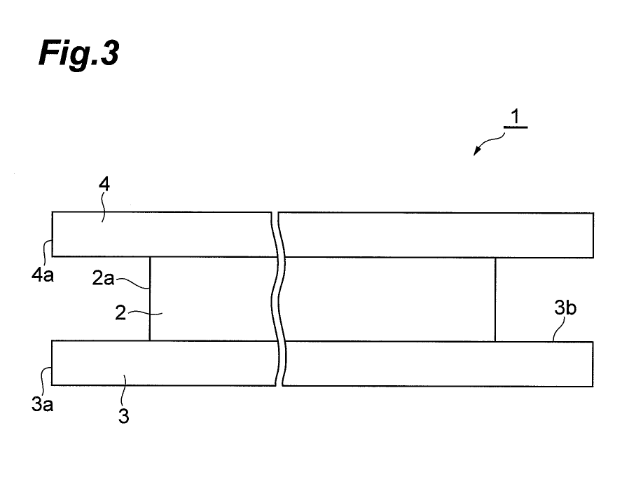

In other words, as shown in FIG. 2 and FIG. 3, a pressure-sensitive adhesive sheet 1 according to this embodiment comprises a transparent, film-shaped pressure-sensitive adhesive layer 2, and a heavy release separator 3 (one base material) and a light release separator 4 (the other base material) that sandwich the pressure-sensitive adhesive layer 2. This pressure-sensitive adhesive layer 2 is, for example, a transparent film disposed between a transparent protective plate and a touch panel or between the touch panel and a liquid crystal display unit in an image display device, such as a touch panel type display for a portable terminal.

The pressure-sensitive adhesive layer 2 is formed, for example, by applying a pressure-sensitive adhesive resin composition comprising the above alkyl (meth)acrylate component in which the number of carbon atoms of an alkyl group is 4 to 18, and a component having a (meth)acryloyl group, added as required, to the heavy release separator 3 with any thickness, irradiating this with active energy rays for curing, and then cutting to a desired size. As a light source of active energy rays, those having a light emission distribution at a wavelength of 400 nm or less are preferred, and, for example, low pressure mercury lamps, medium pressure mercury lamps, high pressure mercury lamps, ultrahigh pressure mercury lamps, chemical lamps, black light lamps, metal halide lamps, and microwave-excited mercury lamps can be used. In addition, irradiation energy is not particularly limited, and is preferably 160 to 650 mJ/cm², more preferably 180 to 600 mJ/cm², and further preferably 200 to 500 mJ/cm², in order to set the shear storage modulus at 25° C. of the pressure-sensitive adhesive layer to 30 to 150 kPa.

The pressure-sensitive adhesive layer 2 is formed from a pressure-sensitive adhesive resin composition comprising a structural unit derived from an alkyl (meth)acrylate in which the number of carbon atoms of an alkyl group is 4 to 18, and therefore achieves the effect of being better in pressure-sensitive adhesive force.

In the pressure-sensitive adhesive layer 2, the above structural unit derived from an alkyl (meth)acrylate in which the number of carbon atoms of an alkyl group is 4 to 18 may be from a polymer component constituting the pressure-sensitive adhesive resin composition, or from a monomer component. In other words, the structural unit may be provided to the pressure-sensitive adhesive resin composition by containing in the polymer component a skeleton derived from an alkyl (meth)acrylate in which the number of carbon atoms of an alkyl group is 4 to 18, or the structural unit may be provided by containing in the monomer component an alkyl (meth)acrylate in which the number of carbon atoms of an alkyl group is 4 to 18. However, from the viewpoint of improving the transparency of the pressure-sensitive adhesive layer 2, it is preferred that the structural unit is from both the polymer component and the monomer component.

From the viewpoint of improving pressure-sensitive adhesiveness, transparency, and handling properties, it is preferred that the content of the structural unit derived from an alkyl (meth)acrylate in which the number of carbon atoms of an alkyl group is 4 to 18 is 30 to 90% by mass with respect to the total mass of the pressure-sensitive adhesive layer 2. From the above viewpoint, the content is more preferably 40 to 85% by mass, and further preferably 50 to 80% by mass.

It is preferred that the pressure-sensitive adhesive resin composition further has a structural unit derived from (meth)acryloylmorpholine. The (meth)acryloylmorpholine is specifically a compound represented by formula (a). From the viewpoint of improving pressure-sensitive adhesiveness, transparency, and handling properties, it is preferred that the content of the structural unit derived from (meth)acryloylmorpholine is 10 to 40% by mass with respect to the total mass of the pressure-sensitive adhesive layer 2. From the above viewpoint, the content is more preferably 15 to 35% by mass, and further preferably 18 to 32% by mass.

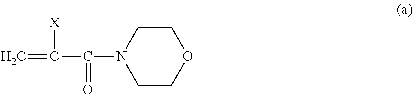

wherein X represents a hydrogen atom or a methyl group.

It is preferred that the pressure-sensitive adhesive layer 2 has physical properties as described below. In other words, it is preferred that a shear storage modulus at 25° C. is 30 to 150 kPa. In addition, it is preferred that glass transition temperature (Tg) is −30 to 10° C. In addition, it is preferred that tan δ at −20 to 25° C. is 0.5 to 1.0.

Here, tan δ is a value in which a loss modulus is divided by a shear storage modulus, and the loss modulus and the shear storage modulus are values measured by a wide area dynamic viscoelasticity measuring device. The glass transition temperature, the loss modulus, and the shear storage modulus are specifically measured by the following method.

(Measurement of Glass Transition Temperature, Loss Modulus, and Shear Storage Modulus)

A pressure-sensitive adhesive layer having a thickness of 0.5 mm, a width of 10 mm, and a length of 10 mm is fabricated, and measurement can be performed under the conditions “shear sandwich mode, frequency: 1.0 Hz, measurement temperature range: −20 to 100° C., heating rate: 5° C./min” using a wide area dynamic viscoelasticity measuring device (Solids Analyzer RSA-II manufactured by Rheometric Scientific).

In the pressure-sensitive adhesive layer 2, if the shear storage modulus at 25° C. is less than 30 kPa, cutting properties (punching properties) decrease. On the other hand, if the shear storage modulus at 25° C. is more than 150 kPa, step height covering properties decrease. From the above viewpoint, the shear storage modulus at 25° C. is preferably in the range of 35 to 120 kPa, more preferably in the range of 35 to 110 kPa.

The glass transition temperature of the pressure-sensitive adhesive layer 2 is preferably in the range of −30 to 10° C., more preferably in the range of −20 to 0° C., from the viewpoint of keeping step height covering properties and film forming properties good. When the glass transition temperature is 10° C. or less, there is a tendency that pressure-sensitive adhesiveness and step height covering properties can be improved. When the glass transition temperature is −30° C. or more, there is a tendency that when the light release separator 4 described later is peeled, it is easy to peel the light release separator 4 well. The glass transition temperature in this application is a temperature at which tan δ shows a peak, in the above measurement temperature range. However, when two or more tan δ peaks are observed in this temperature range, a temperature at which the largest value of tan δ is shown is taken as the glass transition temperature.

In addition, in the pressure-sensitive adhesive layer 2, when the tan δ at −20 to 25° C. is 0.5 or more, there is a tendency that step height covering properties can be improved. On the other hand, when the tan δ at −20 to 25° C. is 1.0 or less, there is a tendency that film formation is good. From the above viewpoint, the tan δ at −20 to 25° C. is more preferably in the range of 0.6 to 1.0.

The thickness of the pressure-sensitive adhesive layer 2 is not particularly limited because it is appropriately adjusted according to an application and method used, and the thickness of the pressure-sensitive adhesive layer 2 is preferably about 0.02 to 3 mm, more preferably 0.1 to 1 mm, and further preferably 0.15 mm (150 μm) to 0.5 mm (500 μm). When the pressure-sensitive adhesive layer 2 is used in this range, a particularly excellent effect as a transparent pressure-sensitive adhesive sheet for bonding an optical member to a display is exhibited.

The pressure-sensitive adhesive resin composition contains a (meth)acrylic acid derivative polymer (A), a (meth)acrylic acid derivative monomer having one (meth)acryloyl group in a molecule (B), a crosslinking agent having a bifunctional (meth)acryloyl group (C), and a photopolymerization initiator (D).

[Component (A): (Meth)Acrylic Acid Derivative Polymer (A)]

The (meth)acrylic acid derivative polymer (A) refers to one in which one monomer having one (meth)acryloyl group in a molecule is polymerized, or two or more monomers having one (meth)acryloyl group in a molecule are copolymerized in combination. In a range in which the effect of this embodiment is not impaired, the component (A) may be one in which a compound having two or more (meth)acryloyl groups in a molecule, or a polymerizable compound having no (meth)acryloyl group (a compound having one polymerizable unsaturated bond in a molecule, such as acrylonitrile, styrene, vinyl acetate, ethylene, or propylene, or a compound having two or more polymerizable unsaturated bonds in a molecule, such as divinylbenzene) is copolymerized with a monomer having one (meth)acryloyl group in a molecule.

Examples of the monomer having one (meth)acryloyl group in a molecule, forming the component (A), include (meth)acrylic acid; (meth)acrylic acid amide; (meth)acryloylmorpholine (the compound represented by formula (a)); alkyl (meth)acrylates in which the number of carbon atoms of an alkyl group is 1 to 18, such as methyl (meth)acrylate, ethyl (meth)acrylate, n-butyl (meth)acrylate, isobutyl (meth)acrylate, tert-butyl (meth)acrylate, n-pentyl (meth)acrylate, n-hexyl (meth)acrylate, n-octyl (meth)acrylate, isooctyl (meth)acrylate, 2-ethylhexyl (meth)acrylate, isodecyl (meth)acrylate, dodecyl (meth)acrylate (n-lauryl (meth)acrylate), and stearyl (meth)acrylate; (meth)acrylates having an aromatic ring, such as benzyl (meth)acrylate and phenoxyethyl (meth)acrylate; (meth)acrylates having an alicyclic ring, such as cyclohexyl (meth)acrylate, isobornyl (meth)acrylate, and dicyclopentanyl (meth)acrylate; tetrahydrofurfuryl (meth)acrylate; (meth)acrylamide derivatives, such as N,N-dimethylaminoethyl (meth)acrylate, N,N-dimethylaminopropyl(meth)acrylamide, N,N-dimethyl(meth)acrylamide, N-isopropyl(meth)acrylamide, N,N-diethyl(meth)acrylamide, and N-hydroxyethyl(meth)acrylamide; (meth)acrylates having an isocyanate group, such as 2-(2-methacryloyloxyethyloxy)ethyl isocyanate and 2-(meth)acryloyloxyethyl isocyanate; and alkylene glycol chain-containing (meth)acrylates.

Among the above compounds, an alkyl (meth)acrylate in which the number of carbon atoms of an alkyl group is 4 to 18, represented by formula (b), is preferably contained in the component (A), and a (meth)acrylate having an alkyl group having 6 to 12 carbon atoms is more preferably contained. In addition, the content of such a (meth)acrylate is preferably 50 to 90% by mass, more preferably 60 to 80% by mass, and further preferably 65 to 75% by mass, with respect to the total mass of a copolymerized polymer. When the content of the (meth)acrylate represented by formula (b) is in such a range, the processability of a formed pressure-sensitive adhesive layer improves, and close adhesiveness between the pressure-sensitive adhesive layer and a transparent protective plate (a glass substrate, a plastic substrate, or the like) also improves. A polymer having such a copolymerization proportion can generally be obtained by blending monomers in the same proportion as the above copolymerization proportion and copolymerizing the monomers. In addition, it is more preferred that a polymerization rate is set to approach substantially 100% by mass.

CH₂═CXCOOR (b)

wherein X represents a hydrogen atom or a methyl group, and R represents an alkyl group having 4 to 18 carbon atoms.

Examples of the alkyl (meth)acrylate in which the number of carbon atoms of an alkyl group is 4 to 18 include n-butyl (meth)acrylate, n-pentyl (meth)acrylate, n-hexyl (meth)acrylate, n-octyl (meth)acrylate, isooctyl (meth)acrylate, 2-ethylhexyl (meth)acrylate, dodecyl (meth)acrylate, and stearyl (meth)acrylate, and among them, n-butyl (meth)acrylate, isooctyl (meth)acrylate, 2-ethylhexyl (meth)acrylate, and n-octyl (meth)acrylate are preferred, and 2-ethylhexyl (meth)acrylate is more preferred. In addition, alkyl acrylates are more preferred than alkyl methacrylates. Two or more types of these alkyl (meth)acrylates may be used in combination.

Other monomers copolymerized with the alkyl (meth)acrylate in which the number of carbon atoms of an alkyl group is 4 to 18 are not limited to those described above, and monomers having a polar group, such as a hydroxyl group, a morpholino group, an amino group, a carboxyl group, a cyano group, a carbonyl group, a nitro group, or a group derived from an alkylene glycol, are preferred. The pressure-sensitive adhesiveness between the pressure-sensitive adhesive layer and a transparent protective plate improves by (meth)acrylates having these polar groups.

Particularly, it is preferred to use the alkyl (meth)acrylate in which the number of carbon atoms of an alkyl group is 4 to 18 and an alkylene glycol chain-containing (meth)acrylate represented by formula (x) in combination.

CH₂═CXCOO(CₚH₂ₚO)_{q}R (x)

wherein X represents a hydrogen atom or a methyl group, R represents a hydrogen atom or an alkyl group having 1 to 10 carbon atoms, p represents an integer of 2 to 4, and q represents an integer of 1 to 10.

Examples of the alkylene glycol chain-containing (meth)acrylate represented by formula (x) include hydroxyl group-containing (meth)acrylates, such as 2-hydroxyethyl (meth)acrylate, 1-hydroxyethyl (meth)acrylate, 2-hydroxypropyl (meth)acrylate, 3-hydroxypropyl (meth)acrylate, 1-hydroxypropyl (meth)acrylate, 4-hydroxybutyl (meth)acrylate, 3-hydroxybutyl (meth)acrylate, 2-hydroxybutyl (meth)acrylate, and 1-hydroxybutyl (meth)acrylate; polyethylene glycol mono(meth)acrylates, such as diethylene glycol mono(meth)acrylate, triethylene glycol mono(meth)acrylate, tetraethylene glycol mono(meth)acrylate, and hexaethylene glycol mono(meth)acrylate; polypropylene glycol mono(meth)acrylates, such as dipropylene glycol mono(meth)acrylate, tripropylene glycol mono(meth)acrylate, and octapropylene glycol mono(meth)acrylate; polybutylene glycol mono(meth)acrylates, such as dibutylene glycol mono(meth)acrylate and tributylene glycol mono(meth)acrylate; and alkoxypolyalkylene glycol (meth)acrylates, such as methoxytriethylene glycol (meth)acrylate, methoxytetraethylene glycol (meth)acrylate, methoxyhexaethylene glycol (meth)acrylate, methoxyoctaethylene glycol (meth)acrylate, methoxynonaethylene glycol (meth)acrylate, methoxypolyethylene glycol (meth)acrylate, methoxyheptapropylene glycol (meth)acrylate, ethoxytetraethylene glycol (meth)acrylate, butoxyethylene glycol (meth)acrylate, and butoxydiethylene glycol (meth)acrylate. Among these, 2-hydroxyethyl (meth)acrylate, 1-hydroxyethyl (meth)acrylate, 2-hydroxypropyl (meth)acrylate, 3-hydroxypropyl (meth)acrylate, 1-hydroxypropyl (meth)acrylate, 4-hydroxybutyl (meth)acrylate, 3-hydroxybutyl (meth)acrylate, 2-hydroxybutyl (meth)acrylate, and 1-hydroxybutyl (meth)acrylate are preferred, 2-hydroxyethyl (meth)acrylate and 4-hydroxybutyl (meth)acrylate are more preferred, and 2-hydroxyethyl (meth)acrylate is further preferred. In addition, two or more types of these alkylene glycol chain-containing (meth)acrylates may be used in combination.

In addition, it is preferred that the monomer forming the component (A) contains a (meth)acrylate represented by formula (a), which is a (meth)acrylate having a morpholino group. Particularly, when (meth)acryloylmorpholine is not contained in the component (B) described in detail later, it is preferred to contain (meth)acryloylmorpholine in the component (A).

For the weight average molecular weight of the component (A), it is preferred that a value obtained by converting using the calibration curve of standard polystyrene with gel permeation chromatography (GPC) is 80000 to 700000. When the weight average molecular weight is 80000 or more, a pressure-sensitive adhesive layer having pressure-sensitive adhesive force in which stripping is less likely to occur on a transparent protective plate or the like can be obtained, and on the other hand, when the weight average molecular weight is 700000 or less, the viscosity of the pressure-sensitive adhesive resin composition is not too high, and processability when the pressure-sensitive adhesive resin composition is formed into a sheet-shaped pressure-sensitive adhesive layer is better. From the above viewpoint, the weight average molecular weight of the component (A) is more preferably 100000 to 500000, and further preferably 100000 to 300000.

As a method for polymerizing the component (A), known polymerization methods, such as solution polymerization, emulsion polymerization, suspension polymerization, and bulk polymerization, can be used.

As a polymerization initiator when the component (A) is polymerized, compounds that generate a radical by heat can be used. Specific examples include organic peroxides, such as benzoyl peroxide and lauroyl peroxide; and azo-based compounds, such as 2,2′-azobisisobutyronitrile and 2,2′-azobis(2-methylbutyronitrile).

The content of the component (A) is preferably 15 to 80% by mass, more preferably 15 to 60% by mass, and further preferably 15 to 50% by mass, with respect to the total mass of the pressure-sensitive adhesive resin composition. When the content of the component (A) is 15 to 80% by mass, the viscosity of the pressure-sensitive adhesive resin composition falls within a proper viscosity range when the pressure-sensitive adhesive layer is fabricated, and processability is better. In addition, in the obtained pressure-sensitive adhesive layer, pressure-sensitive adhesiveness to transparent protective plates, such as glass substrates and plastic substrates, is good.

[Component (B): (Meth)Acrylic Acid Derivative Monomer Having One (Meth)Acryloyl Group in Molecule (B)]

Examples of the (meth)acrylic acid derivative monomer having one (meth)acryloyl group in a molecule (B) include those similar to the compounds illustrated as the above monomer having one (meth)acryloyl group in a molecule, forming the component (A).

In this embodiment, from the viewpoint of ensuring pressure-sensitive adhesiveness and transparency, the component (B) preferably contains an alkyl (meth)acrylate in which the number of carbon atoms of an alkyl group is 4 to 18, more preferably contains an alkyl (meth)acrylate in which the number of carbon atoms of an alkyl group is 6 to 12, and further preferably contains 2-ethylhexyl (meth)acrylate. In addition, from the viewpoint of pressure-sensitive adhesiveness, transparency, and handling properties, it is preferred that the component (B) contains (meth)acryloylmorpholine represented by formula (a).

It is preferred that the content of the component (B) is 15 to 80% by mass with respect to the total mass of the pressure-sensitive adhesive resin composition. When the content of the component (B) is in the range of 15 to 80% by mass, the viscosity of the pressure-sensitive adhesive resin composition falls within a proper viscosity range when the pressure-sensitive adhesive layer is fabricated, and processability is better. In addition, the pressure-sensitive adhesiveness and transparency of the obtained pressure-sensitive adhesive sheet is also better. The obtained pressure-sensitive adhesive layer is also better in step height covering properties. From the above viewpoint, the content of the component (B) is more preferably 30 to 80% by mass, further preferably 40 to 80% by mass.

[Component (C): Crosslinking Agent Having Bifunctional (Meth)Acryloyl Group (C)]

Specific examples of the component (C) preferably include compounds represented by formulas (c) to (h). In formulas (c), (d), and (e), s represents an integer of 1 to 20, and in formulas (f) and (g), m and n each independently represent an integer of 1 to 10.

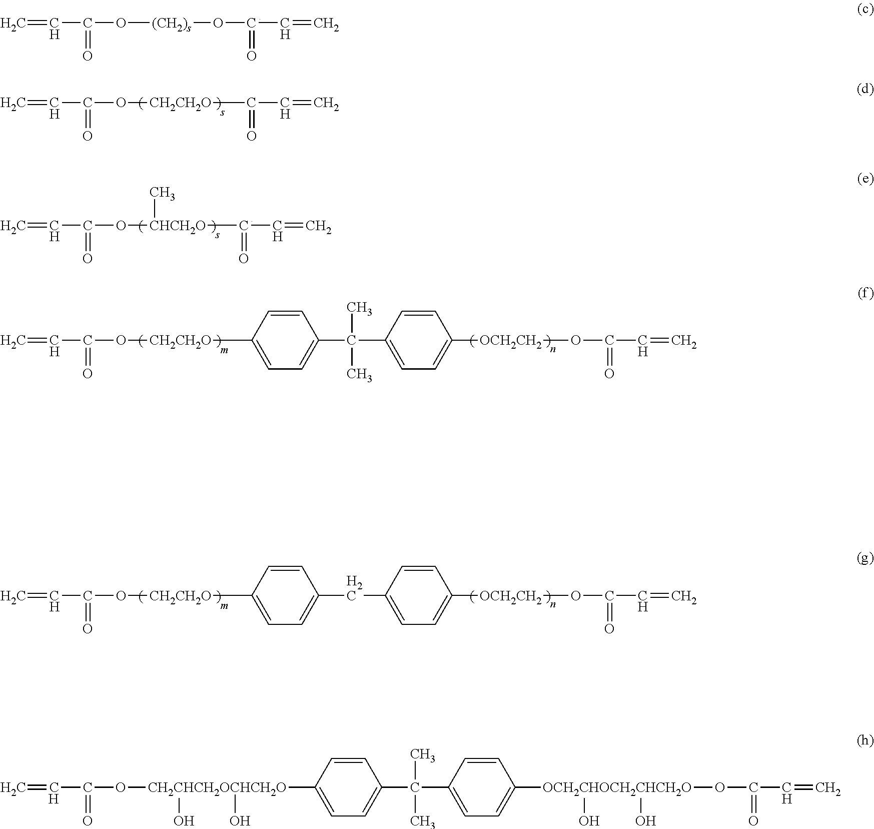

In addition, urethane di(meth)acrylates having a urethane bond can also be used as the component (C).

From the viewpoint of compatibility with other components being good, it is preferred that the urethane di(meth)acrylates having a urethane bond have a polyalkylene glycol chain. In addition, from the viewpoint of ensuring transparency, it is preferred that the urethane di(meth)acrylates having a urethane bond have an alicyclic structure. If the compatibility of the component (C) with the component (A) and the component (B) is low, a cured product may become whitish.

In the component (C), weight average molecular weight is preferably 100000 or less, more preferably 300 to 100000, and further preferably 500 to 80000, from the viewpoint of being able to further suppress the occurrence of bubbles and stripping at high temperature or at high temperature and high humidity.

It is preferred that the content of the component (C) is 15% by mass or less with respect to the total mass of the pressure-sensitive adhesive resin composition. When the content is 15% by mass or less, crosslinking density is not too high, and therefore, a pressure-sensitive adhesive layer that has more sufficient pressure-sensitive adhesiveness, has high elasticity, and has no brittleness can be obtained. In addition, from the viewpoint of being able to further improve step height covering properties, the content of the component (C) is more preferably 10% by mass or less, further preferably 7% by mass or less.

There is no particular limitation for the lower limit of the content of the component (C), and the lower limit is preferably 0.1% by mass or more, more preferably 2% by mass or more, and further preferably 3% by mass or more, from the viewpoint of making film forming properties better.

[Component (D): (D) Photopolymerization Initiator]

The component (D) is contained in the pressure-sensitive adhesive resin composition in order to promote the curing reaction of the composition by irradiation with active energy rays. Here, the active energy rays refer to ultraviolet rays, electron beams, α-rays, β-rays, γ rays, or the like.

The component (D) is not particularly limited, and publicly known materials, such as a benzophenone type, an anthraquinone type, a benzoyl type, sulfonium salts, diazonium salts, and onium salts, can be used.

Specific examples of the component (D) include aromatic ketone compounds, such as benzophenone, N,N′-tetramethyl-4,4′-diaminobenzophenone (Michler's ketone), N,N-tetraethyl-4,4′-diaminobenzophenone, 4-methoxy-4,4′-dimethylaminobenzophenone, α-hydroxyisobutylphenone, 2-ethylanthraquinone, tert-butylanthraquinone, 1,4-dimethylanthraquinone, 1-chloroanthraquinone, 2,3-dichloroanthraquinone, 3-chloro-2-methylanthraquinone, 1,2-benzanthraquinone, 2-phenylanthraquinone, 1,4-naphthoquinone, 9,10-phenanthraquinone, thioxanthone, 2-chlorothioxanthone, 1-hydroxycyclohexyl phenyl ketone, 2,2-dimethoxy-1,2-diphenylethan-1-one, 2-hydroxy-2-methyl-1-phenylpropan-1-one, and 2,2-diethoxyacetophenone; benzoin compounds, such as benzoin, methylbenzoin, and ethylbenzoin; benzoin ether compounds, such as benzoin methyl ether, benzoin ethyl ether, benzoin isobutyl ether, and benzoin phenyl ether; benzyl compounds, such as benzyl and benzyl dimethyl ketal; ester compounds, such as 13-(acridin-9-yl)(meth)acrylic acid ester; acridine compounds, such as 9-phenylacridine, 9-pyridylacridine, and 1,7-diacridinoheptane; 2,4,5-triarylimidazole dimers, such as a 2-(o-chlorophenyl)-4,5-diphenylimidazole dimer, a 2-(o-chlorophenyl)-4,5-di(m-methoxyphenyl)imidazole dimer, a 2-(o-fluorophenyl)-4,5-diphenylimidazole dimer, a 2-(o-methoxyphenyl)-4,5-diphenylimidazole dimer, a 2-(p-methoxyphenyl)-4,5-diphenylimidazole dimer, a 2,4-di(p-methoxyphenyl)-5-phenylimidazole dimer, a 2-(2,4-dimethoxyphenyl)-4,5-diphenylimidazole dimer, and a 2-(p-methylmercaptophenyl)-4,5-diphenylimidazole dimer; 2-benzyl-2-dimethylamino-1-(4-morpholinophenyl)-1-butanone; 2-methyl-1-[4-(methylthio)phenyl]-2-morpholino-1-propane; bis(2,4,6-trimethylbenzoyl)-phenylphosphine oxide; and oligo(2-hydroxy-2-methyl-1-(4-(1-methylvinyl)phenyl)propanone). These compounds may be used alone, or a plurality of these compounds may be used in combination.

Particularly, from the viewpoint of suppressing the coloration of the pressure-sensitive adhesive resin composition, examples of the component (D) include α-hydroxyalkylphenone-based compounds, such as 1-hydroxycyclohexyl phenyl ketone, 2-hydroxy-2-methyl-1-phenyl-propan-1-one, and 1-[4-(2-hydroxyethoxy)-phenyl]-2-hydroxy-2-methyl-1-propan-1-one; acylphosphine oxide-based compounds, such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide; and oligo(2-hydroxy-2-methyl-1-(4-(1-methylvinyl)phenyl)propanone), and particularly, combinations of these are preferred.

In addition, particularly, in order to fabricate a thick sheet (pressure-sensitive adhesive layer), it is preferred that the component (D) comprises an acylphosphine oxide-based compound, such as bis(2,4,6-trimethylbenzoyl)-phenylphosphine oxide, bis(2,6-dimethoxybenzoyl)-2,4,4-trimethyl-pentylphosphine oxide, or 2,4,6-trimethylbenzoyl-diphenylphosphine oxide.

The content of the component (D) in this embodiment is preferably 0.05 to 5% by mass, more preferably 0.1 to 3% by mass, and further preferably 0.1 to 0.5% by mass, with respect to the total mass of the pressure-sensitive adhesive resin composition. By setting the content of the component (D) to 5% by mass or less, a pressure-sensitive adhesive layer in which transmittance is high and a hue is not yellowish and which is also better in step height covering properties can be obtained.

[Other Additives]

Apart from the above components (A), (B), (C), and (D), various additives may be contained in the pressure-sensitive adhesive resin composition as required. Examples of the various additives that can be contained include polymerization inhibitors, such as para-methoxyphenol, added for the purpose of enhancing the storage stability of the pressure-sensitive adhesive resin composition, antioxidants, such as triphenyl phosphite, added for the purpose of enhancing the heat resistance of the pressure-sensitive adhesive layer obtained by photocuring the pressure-sensitive adhesive resin composition, light stabilizers, such as HALS (Hindered Amine Light Stabilizer), added for the purpose of enhancing the resistance of the pressure-sensitive adhesive resin composition to light, such as ultraviolet rays, and silane coupling agents added for enhancing the close adhesiveness of the pressure-sensitive adhesive resin composition to glass and the like.

When the pressure-sensitive adhesive sheet for an image display device is obtained, the pressure-sensitive adhesive layer is arranged to be sandwiched between a base material of a polymer film, such as a polyethylene terephthalate film, (the heavy release separator 3) and a cover film of the same material (the light release separator 4). At this time, in order to control peelability between the pressure-sensitive adhesive layer and the base material, such as a polyethylene terephthalate film, and the cover film, a surfactant, such as a polydimethylsiloxane type or a fluorine type, can be contained in the pressure-sensitive adhesive resin composition.

These additives may be used alone, and a plurality of additives may be contained in combination. The content of these other additives is usually a small amount compared with the total content of the above (A), (B), (C), and (D), and is generally about 0.01 to 5% by mass with respect to the total mass of the pressure-sensitive adhesive resin composition.

As the heavy release separator 3, for example, polymer films, such as polyethylene terephthalate, polypropylene, polyethylene, and polyesters, are preferred, and among them, a polyethylene terephthalate film (hereinafter sometimes referred to as a “PET film”) is more preferred. The thickness of the heavy release separator 3 is preferably 50 μm or more and 200 μm or less, more preferably 60 μm or more and 150 μm or less, and further preferably 70 μm or more and 130 μm or less, from the viewpoint of workability. It is preferred that the planar shape of the heavy release separator 3 is larger than the planar shape of the pressure-sensitive adhesive layer 2, and the outer edge of the heavy release separator 3 projects more outward than the outer edge of the pressure-sensitive adhesive layer 2. An amount that the outer edge of the heavy release separator 3 projects more than the outer edge of the pressure-sensitive adhesive layer 2 is preferably 2 mm or more and 20 mm or less, more preferably 4 mm or more and 10 mm or less, from the viewpoint of the ease of handling, the ease of stripping, and being able to further reduce the attachment of dust and the like. When the planar shape of the pressure-sensitive adhesive layer 2 and the heavy release separator 3 is a rectangular shape, such as a rectangle, the amount that the outer edge of the heavy release separator 3 projects more than the outer edge of the pressure-sensitive adhesive layer 2 is preferably 2 mm or more and 20 mm or less on at least one side, more preferably 4 mm or more and 10 mm or less on at least one side, further preferably 2 mm or more and 20 mm or less on all sides, and particularly preferably 4 mm or more and 10 mm or less on all sides.

As the light release separator 4, for example, polymer films, such as polyethylene terephthalate, polypropylene, polyethylene, and polyesters, are preferred, and among them, a polyethylene terephthalate film is more preferred. The thickness of the light release separator 4 is preferably 25 μm or more and 150 μm or less, more preferably 30 μm or more and 100 μm or less, and further preferably 40 μm or more and 75 μm or less, from the viewpoint of workability. It is preferred that the planar shape of the light release separator 4 is larger than the planar shape of the pressure-sensitive adhesive layer 2, and the outer edge of the light release separator 4 projects more outward than the outer edge of the pressure-sensitive adhesive layer 2. An amount that the outer edge of the light release separator 4 projects more than the outer edge of the pressure-sensitive adhesive layer 2 is preferably 2 mm or more and 20 mm or less, more preferably 4 mm or more and 10 mm or less, from the viewpoint of the ease of handling, the ease of stripping, and being able to further reduce the attachment of dust and the like. When the planar shape of the pressure-sensitive adhesive layer 2 and the light release separator 4 is a rectangular shape, such as a rectangle, the amount that the outer edge of the light release separator 4 projects more than the outer edge of the pressure-sensitive adhesive layer 2 is preferably 2 mm or more and 20 mm or less on at least one side, more preferably 4 mm or more and 10 mm or less on at least one side, further preferably 2 mm or more and 20 mm or less on all sides, and particularly preferably 4 mm or more and 10 mm or less on all sides.

It is preferred that peel strength between the light release separator 4 and the pressure-sensitive adhesive layer 2 is lower than peel strength between the heavy release separator 3 and the pressure-sensitive adhesive layer 2. Thus, the heavy release separator 3 is more difficult to peel from the pressure-sensitive adhesive layer 2 than the light release separator 4. In addition, as described later, blades B are passed through the pressure-sensitive adhesive layer 2 toward a heavy release separator 3 side, and therefore, the outer edge portion of the pressure-sensitive adhesive layer 2 is pressed against the heavy release separator 3. Thus, the heavy release separator 3 is even more difficult to peel from the pressure-sensitive adhesive layer 2 than the light release separator 4, and the light release separator 4 can be peeled before peeling occurs in the heavy release separator 3. Therefore, the separators 3 and 4 can be peeled one by one, and the work of peeling the separators 3 and 4 and affixing the pressure-sensitive adhesive layer 2 to separate adherends can be reliably performed one by one. The peel strength between the heavy release separator 3 and the pressure-sensitive adhesive layer 2, and the peel strength between the light release separator 4 and the pressure-sensitive adhesive layer 2 can be adjusted, for example, by performing the surface treatment of the heavy release separator 3 and the light release separator 4, or the like. Examples of the surface treatment method include performing release treatment with a silicone-based compound or a fluorine-based compound.

<Method for Producing Adhesive Sheet for Image Display Device>

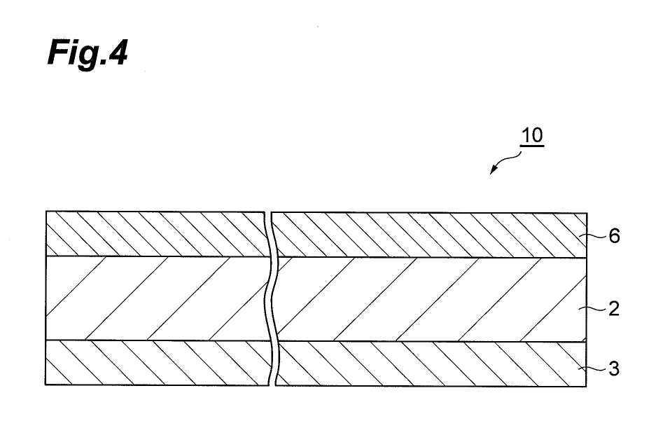

The pressure-sensitive adhesive sheet 1 described above is produced as follows. First, as shown in FIG. 4, a matrix film 10 in which the pressure-sensitive adhesive layer 2 is formed on the heavy release separator 3 and a temporary separator 6 is formed on the pressure-sensitive adhesive layer 2 is prepared. The temporary separator 6 is, for example, a layer composed of the same material as that of the light release separator 4.

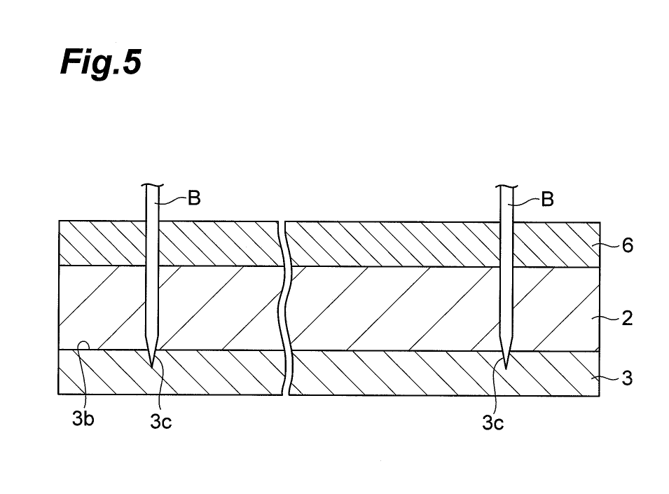

Then, as shown in FIG. 5, the temporary separator 6 and the pressure-sensitive adhesive layer 2 are cut into a desired shape by a punching device (not shown) comprising blades B. The punching device may be a crank type punching device, a reciprocating punching device, or a rotary punching device. From the viewpoint of the peelability of the base materials, a rotary punching device is preferred. In this step, it is preferred to pass the blades B through the temporary separator 6 and the pressure-sensitive adhesive layer 2 at a depth reaching the heavy release separator 3, and cut the temporary separator 6 and the pressure-sensitive adhesive layer 2. Thus, cut portions 3c are formed in the heavy release separator 3, and the peeling of the heavy release separator 3 from the pressure-sensitive adhesive layer 2 is easy.

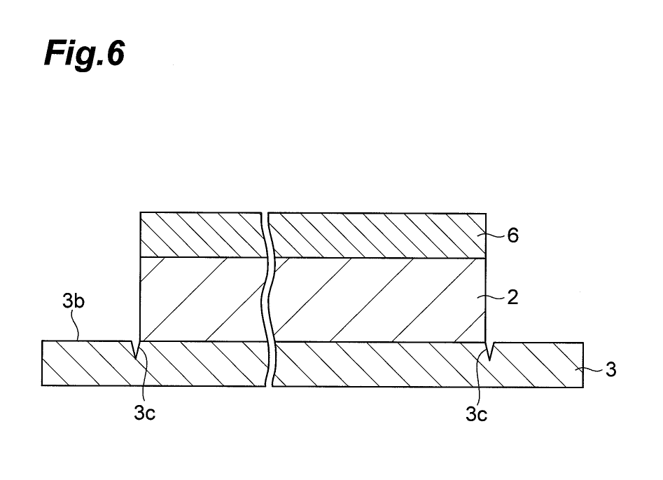

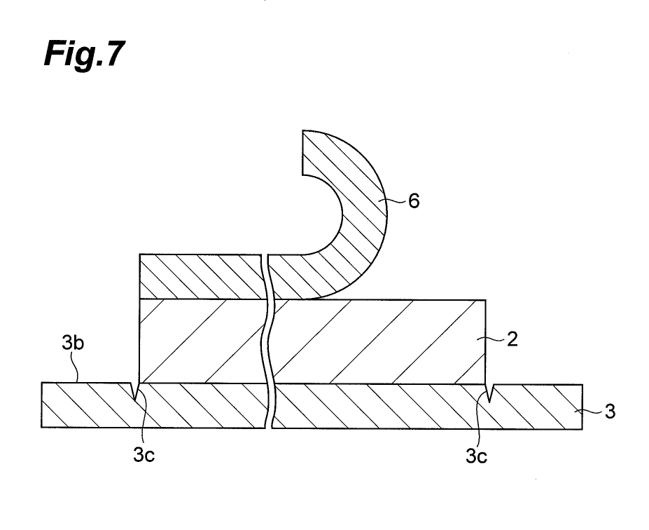

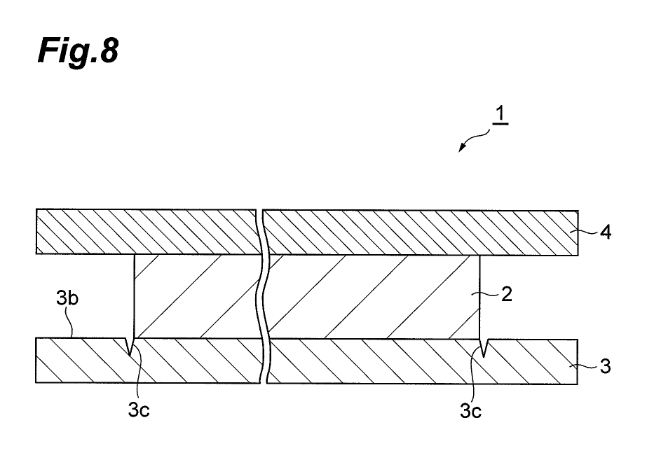

Then, the outer portions of the temporary separator 6 and the pressure-sensitive adhesive layer 2 are removed as shown in FIG. 6, the temporary separator 6 is peeled from the pressure-sensitive adhesive layer 2 as shown in FIG. 7, and the light release separator 4 is affixed to the pressure-sensitive adhesive layer 2 as shown in FIG. 8. The pressure-sensitive adhesive sheet 1 is completed by the above steps.

<Image Display Device>

Next, an image display device fabricated using the pressure-sensitive adhesive sheet 1 will be described. The pressure-sensitive adhesive layer 2 that the pressure-sensitive adhesive sheet 1 comprises can be applied to various image display devices. Examples of the image display devices include plasma displays (PDP), liquid crystal displays (LCD), cathode-ray tubes (CRT), field emission displays (FED), organic EL displays (OELD), 3D displays, and electronic paper (EP). The pressure-sensitive adhesive layer 2 in this embodiment can also be used for bonding functional layers having functionality, such as an antireflection layer, an antifouling layer, a dye layer, and a hard coat layer, and a transparent protective plate in the image display device in combination.

The above antireflection layer need only be a layer having antireflection properties in which visible light reflectance is 5% or less, and layers in which known antireflection treatment is performed on a transparent base material, such as a transparent plastic film, can be used.

The above antifouling layer is for making a surface difficult to foul, and as such a layer, known layers that are composed of a fluorine-based resin or a silicone-based resin in order to lower surface tension can be used.

The above dye layer is used for enhancing color purity, and is specifically used for reducing unnecessary light when the color purity of light emitted from an image display unit, such as a liquid crystal display unit, is low. Such a layer can be obtained by dissolving in a resin a dye that absorbs an unnecessary portion of light, and film-forming or laminating the resin on a base material film, such as a polyethylene film or a polyester film.

The above hard coat layer is used for increasing surface hardness. As the hard coat layer, for example, those in which an acrylic resin, such as a urethane acrylate or an epoxy acrylate; an epoxy resin; or the like is film-formed or laminated on a base material film, such as a polyethylene film, can be used. Similarly, those in which a hard coat layer is film-formed or laminated on a transparent protective plate, such as glass, an acrylic resin, or a polycarbonate, in order to enhance surface hardness can also be used.

The pressure-sensitive adhesive layer 2 can be laminated on a polarizing plate and used. In this case, the pressure-sensitive adhesive layer 2 can be laminated on the visible surface side of the polarizing plate, or can be laminated on the opposite side.

When the pressure-sensitive adhesive layer 2 is used on the visible surface side of the polarizing plate, the antireflection layer, the antifouling layer, and the hard coat layer can be laminated on the visible surface side of the pressure-sensitive adhesive layer 2, and when the pressure-sensitive adhesive layer 2 is used between the polarizing plate and a liquid crystal cell, these layers having functionality can be laminated on the visible surface side of the polarizing plate.

When such a laminate is provided, the pressure-sensitive adhesive layer 2 can be laminated using a roll laminator, a vacuum bonding machine, or a sheet bonding machine.

It is preferred that the pressure-sensitive adhesive layer 2 is disposed between the image display unit and the transparent protective plate at a visible side front in the image display device, and at a suitable position on the visible side. Specifically, it is preferred that the pressure-sensitive adhesive layer 2 is disposed between the image display unit and the transparent protective plate.

In addition, in an image display device in which a touch panel is combined with an image display unit, it is preferred that the pressure-sensitive adhesive layer 2 is disposed between the touch panel and the image display unit and/or between the touch panel and a transparent protective plate, but a disposition position is not limited to the positions described above as long as the pressure-sensitive adhesive layer 2 in this embodiment can be applied in terms of the configuration of the image display device.

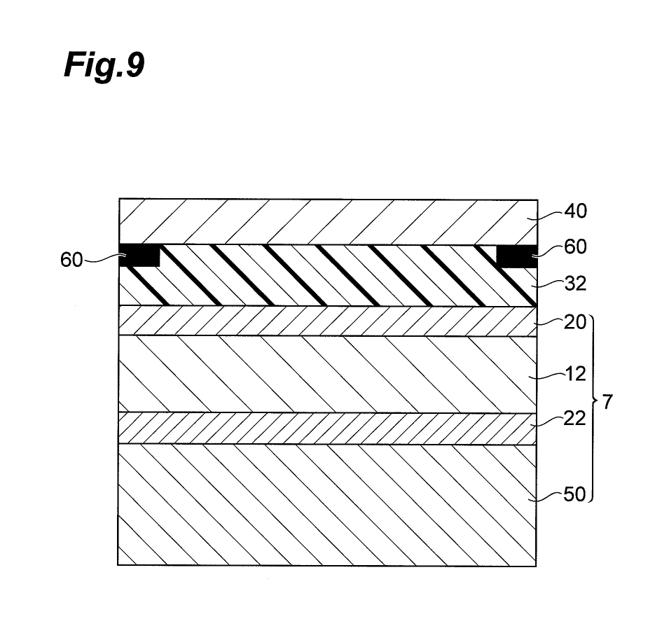

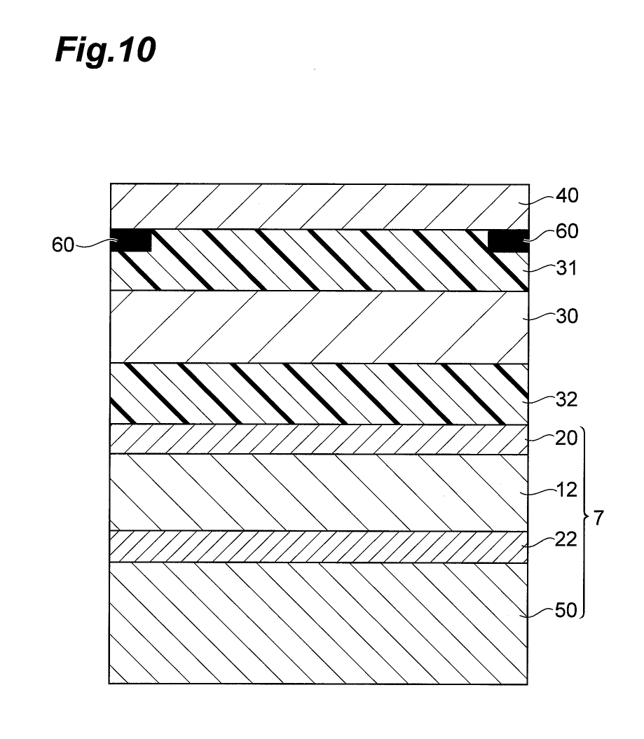

A liquid crystal display device, which is one of image display devices, will be described in detail below as an example, using FIGS. 9 and 10.

FIG. 9 is a side cross-sectional view schematically showing one embodiment of the liquid crystal display device of the present invention. The liquid crystal display device shown in FIG. 9 is composed of an image display unit 7 in which a backlight system 50, a polarizing plate 22, a liquid crystal display cell 12, and a polarizing plate 20 are laminated in this order, a transparent resin layer 32 provided on the upper surface of the polarizing plate 20 that is on the visible side of the liquid crystal display device, and a transparent protective plate (protective panel) 40 provided on the surface of the transparent resin layer 32. A step 60 provided on the surface of the transparent protective plate 40 is filled up by the transparent resin layer 32. The transparent resin layer 32 basically corresponds to the pressure-sensitive adhesive layer in this embodiment. The thickness of the step 60 is different depending on the size of the liquid crystal display device, and the like, and when the thickness is 40 to 100 μm, it is particularly useful to use the pressure-sensitive adhesive layer in this embodiment.

FIG. 10 is a side cross-sectional view schematically showing a liquid crystal display device in which a touch panel is mounted that is one embodiment of the liquid crystal display device of the present invention. The liquid crystal display device shown in FIG. 10 is composed of an image display unit 7 in which a backlight system 50, a polarizing plate 22, a liquid crystal display cell 12, and a polarizing plate 20 are laminated in this order, a transparent resin layer 32 provided on the upper surface of the polarizing plate 20 that is on the visible side of the liquid crystal display device, a touch panel 30 provided on the upper surface of the transparent resin layer 32, a transparent resin layer 31 provided on the upper surface of the touch panel 30, and a transparent protective plate 40 provided on the surface of the transparent resin layer 31. A step 60 provided on the surface of the transparent protective plate 40 is filled up by the transparent resin layer 31. The transparent resin layer 31 and the transparent resin layer 32 basically correspond to the pressure-sensitive adhesive layer in this embodiment.

In the liquid crystal display device in FIG. 10, the transparent resin layer is interposed both between the image display unit 7 and the touch panel 30 and between the touch panel 30 and the transparent protective plate 40 having the step 60, but the transparent resin layer need only be interposed between at least one of these, and particularly when the pressure-sensitive adhesive layer in this embodiment is used, it is preferred that the transparent resin layer is interposed between the touch panel 30 and the transparent protective plate 40 having the step 60. In addition, when the touch panel is an on-cell type, the touch panel and the liquid crystal display cell are integrated. Specific examples thereof include one in which the liquid crystal display cell 12 of the liquid crystal display device in FIG. 9 is replaced by the on-cell type.

According to the liquid crystal display devices shown in FIG. 9 and FIG. 10, the liquid crystal display devices comprise the pressure-sensitive adhesive layer in this embodiment as the transparent resin layer 31 or 32, and therefore have impact resistance, and an image that is without a double image, is clear, and has high contrast is obtained.

For the liquid crystal display cell 12, those composed of a liquid crystal material well known in the art can be used. Liquid crystal display cells are classified into a TN (Twisted Nematic) type, an STN (Super-Twisted Nematic) type, a VA (Vertical Alignment) type, an IPS (In-Place-Switching) type, and the like according to a method for controlling the liquid crystal material, and in the present invention, the liquid crystal display cell may be a liquid crystal display cell using any control method.

As the polarizing plates 20 and 22, polarizing plates common in the art can be used. The surfaces of the polarizing plates may be subjected to treatment, such as antireflection, antifouling, and hard coating. Such surface treatment may be carried out on one surface or both surfaces of the polarizing plate.

As the touch panel 30, those generally used in the art can be used.

The transparent resin layer 31 or 32 can be formed, for example, with a thickness of 0.02 to 3 mm. Particularly, in the curable resin composition in this embodiment, an even better effect can be exhibited by making a thick film, and the curable resin composition can be preferably used when the transparent resin layer 31 or 32 of 0.1 mm or more is formed.

As the transparent protective plate 40, general optical transparent substrates can be used. Specific examples thereof include plates of inorganic matter, such as glass substrates and quartz plates; plastic substrates, such as acrylic resin substrates and polycarbonate plates; and resin sheets, such as thick polyester sheets. When high surface hardness is required, glass substrates and acrylic resin substrates are preferred, and glass substrates are more preferred. Treatment, such as antireflection, antifouling, and hard coating, may be performed on the surfaces of these transparent protective plates. Such surface treatment may be carried out on one surface or both surfaces of the transparent protective plate. A plurality of transparent protective plates can also be used in combination.

The backlight system 50 is typically composed of reflection means, such as a reflection plate, and illumination means, such as a lamp.

<Method for Producing Image Display Device>

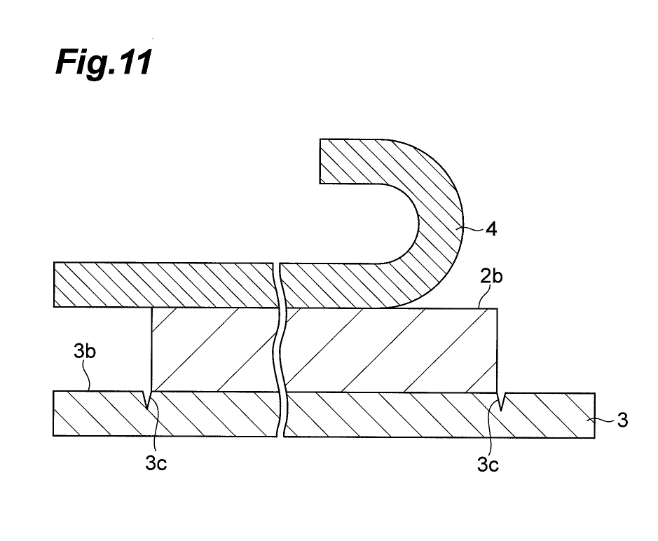

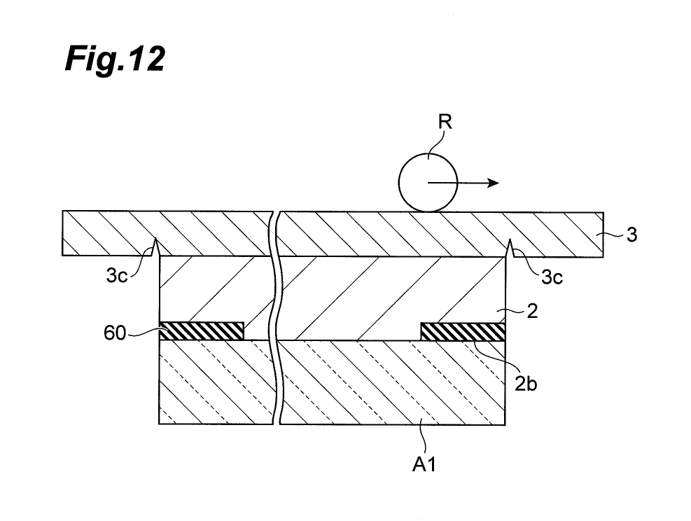

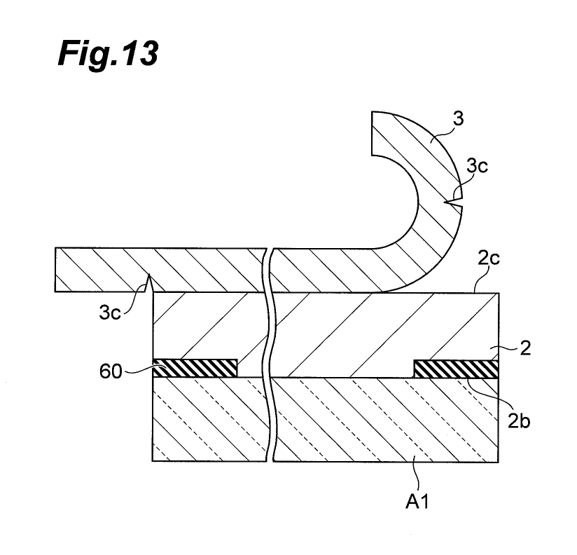

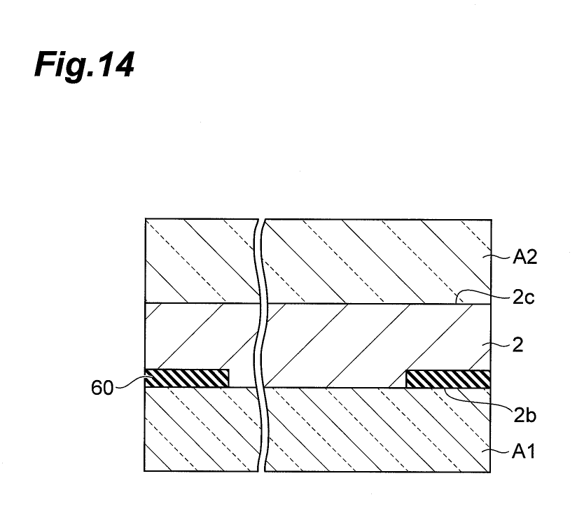

In the assembly of an image display device, and the like, the pressure-sensitive adhesive sheet 1 is used as follows. First, as shown in FIG. 11, the light release separator 4 is peeled from the pressure-sensitive adhesive sheet 1 to expose a pressure-sensitive adhesive surface 2b of the pressure-sensitive adhesive layer 2. Then, as shown in FIG. 12, the pressure-sensitive adhesive surface 2b of the pressure-sensitive adhesive layer 2 is affixed to an adherend A1, and pressed by a roller R or the like. At this time, the step 60 provided on the surface of the adherend A1 is filled up by the pressure-sensitive adhesive layer 2. The adherend A1 is, for example, an image display unit, a transparent protective plate, or a touch panel. Then, as shown in FIG. 13, the heavy release separator 3 is peeled from the pressure-sensitive adhesive layer 2 to expose a pressure-sensitive adhesive surface 2c of the pressure-sensitive adhesive layer 2. Then, as shown in FIG. 14, the pressure-sensitive adhesive surface 2c of the pressure-sensitive adhesive layer 2 is affixed to an adherend A2, and heating and pressurization treatment (autoclave treatment) is performed. The adherend A2 is, for example, an image display unit, a transparent protective plate, or a touch panel. In this manner, it is possible to bond the adherends to each other via the pressure-sensitive adhesive layer 2 to obtain a laminate. For heating and pressurization treatment conditions at this time, temperature is 40 to 80° C., and pressure is 0.3 to 0.8 MPa, and when the step on the adherend surface is 40 to 100 μm, it is preferred that the temperature is 50 to 70° C., and the pressure is 0.4 to 0.7 MPa, from the viewpoint of being able to further remove bubbles in the vicinity of the step. In addition, treatment time is preferably 5 to 60 minutes, more preferably 10 to 50 minutes.

In addition, the above production method comprises the step of irradiating the pressure-sensitive adhesive layer 2 with ultraviolet rays from the side of either one of both adherends (for example, a transparent protective plate and a touch panel) before or after the autoclave treatment. Thus, reliability (the reduction of the generation of bubbles and the suppression of stripping) at high temperature and high humidity and adhesive force can be further improved. From the viewpoint of being able to further improve reliability at high temperature and high humidity, it is preferred to irradiate with ultraviolet rays from the side of the adherend having no step (for example, a touch panel).

The amount of irradiation of ultraviolet rays is not particularly limited, and is preferably about 500 to 5000 mJ/cm². The step of irradiating with ultraviolet rays is preferably performed after the autoclave treatment from the viewpoint of improving reliability at high temperature and high humidity. When a glass substrate (soda lime glass) or an acrylic resin substrate is used as the adherend in the structure obtained in this manner, peel strength between the pressure-sensitive adhesive layer 2 and these substrates is preferably 5 to 30 N/10 mm, more preferably 8 to 30 N/10 mm, and further preferably 10 to 30 N/10 mm. Peel strength can be measured by performing 180 degree peeling (at a peel rate of 300 mm/min for 3 seconds, measurement temperature: 25° C.) using a tensile tester (“RTC-1210” manufactured by ORIENTEC CO., LTD.).

The pressure-sensitive adhesive layer 2 is disposed between the adherend A1 and the adherend A2 by the above steps. Particularly, it is preferred that the pressure-sensitive adhesive layer 2 is disposed between a transparent protective plate and a touch panel or between a touch panel and an image display unit and used.

The liquid crystal display device in FIG. 9 described above can be produced by interposing the pressure-sensitive adhesive layer in this embodiment described above between an image display unit and a transparent protective plate to obtain a laminate. In other words, in the image display device described in FIG. 9, the pressure-sensitive adhesive layer in this embodiment can be laminated on the upper surface of the polarizing plate 20 by a lamination method.

The liquid crystal display device in FIG. 10 described above can be produced by interposing the pressure-sensitive adhesive layer in this embodiment described above between an image display unit and a touch panel and/or between a touch panel and a transparent protective plate to obtain a laminate.

### Second Embodiment

### Pressure-sensitive Adhesive Sheet for Image Display Device

A pressure-sensitive adhesive sheet for an image display device in this embodiment comprises a film-shaped pressure-sensitive adhesive layer, first and second base material layers laminated so as to sandwich the pressure-sensitive adhesive layer, and a carrier layer further laminated on the second base material layer, and the outer edges of the first base material layer and the carrier layer project more outward than the outer edge of the pressure-sensitive adhesive layer.

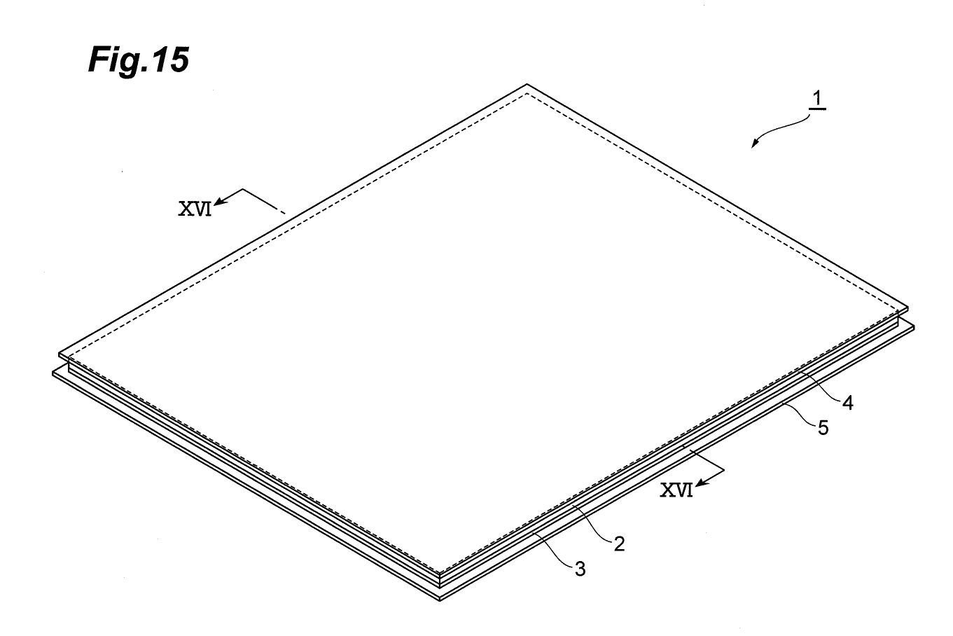

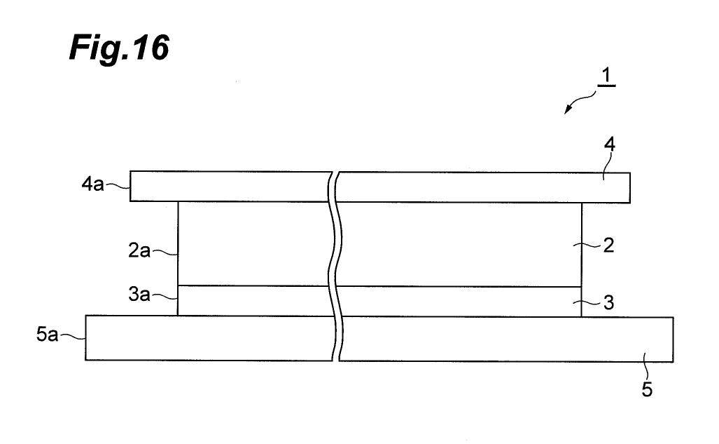

In other words, as shown in FIG. 15 and FIG. 16, a pressure-sensitive adhesive sheet 1 according to this embodiment comprises a transparent, film-shaped pressure-sensitive adhesive layer 2, a light release separator 4 (first base material layer) and a heavy release separator 3 (second base material layer) laminated so as to sandwich the pressure-sensitive adhesive layer 2, and a carrier film 5 (carrier layer) further laminated on the heavy release separator 3.

An outer edge 5a of the carrier film 5 projects more outward than an outer edge 2a of the pressure-sensitive adhesive layer 2. Thus, by pinching the outer edge portion of the carrier film 5 projecting outward, the carrier film 5 can be easily peeled from the second base material layer. In addition, it is preferred that the outer edge 5a of the carrier film 5 projects more outward than an outer edge 4a of the light release separator 4. Thus, the outer edge portion of the carrier film 5 is more easily pinched, and therefore, the carrier film 5 can be more easily peeled. An amount that the outer edge 5a of the carrier film 5 projects more than the outer edge 4a of the light release separator 4 is preferably 0.5 mm or more and 10 mm or less, more preferably 1 mm or more and 5 mm or less, from the viewpoint of the ease of handling, the ease of stripping, and being able to further reduce the attachment of dust and the like. When the planar shape of the carrier film 5, the pressure-sensitive adhesive layer 2, the heavy release separator 3, and the light release separator 4 is a rectangular shape, such as a rectangle, the amount that the outer edge 5a of the carrier film 5 projects more than the outer edge 4a of the light release separator 4 is preferably 0.5 mm or more and 10 mm or less on at least one side, more preferably 1 mm or more and 5 mm or less on at least one side, further preferably 0.5 mm or more and 10 mm or less on all sides, and particularly preferably 1 mm or more and 5 mm or less on all sides.

The heavy release separator 3 is protected by the carrier film 5 until the immediately preceding step, and therefore, flaws on the surface of the heavy release separator 3 decrease. Thus, flaws in the pressure-sensitive adhesive layer 2 can be easily visible, and the pressure-sensitive adhesive layer 2 in which flaws occur can be easily eliminated before being affixed to an adherend.

The carrier film 5 is, for example, a polymer film, such as polyethylene terephthalate, polypropylene, polyethylene, or a polyester, and among them, the carrier film 5 is preferably a polyethylene terephthalate film. The thickness of the carrier film 5 is preferably 15 μm or more and 100 μm or less, more preferably 20 μm or more and 80 μm or less, and further preferably 20 μm or more and 50 μm or less, from the viewpoint of workability.

Peel strength between the light release separator 4 and the pressure-sensitive adhesive layer 2 is lower than peel strength between the heavy release separator 3 and the pressure-sensitive adhesive layer 2. Peel strength between the carrier film 5 and the heavy release separator 3 is lower than the peel strength between the heavy release separator 3 and the pressure-sensitive adhesive layer 2. Here, it is more preferred that the peel strength between the carrier film 5 and the heavy release separator 3 is lower than the peel strength between the light release separator 4 and the pressure-sensitive adhesive layer 2, but even if the peel strength between the carrier film 5 and the heavy release separator 3 is higher than the peel strength between the light release separator 4 and the pressure-sensitive adhesive layer 2, the effect of this application is not impaired.

The peel strength between the carrier film 5 and the heavy release separator 3 is adjusted, for example, by the type of an adhesive layer formed between the carrier film 5 and the heavy release separator 3, and the thickness of the adhesive. Examples of the type of the adhesive formed between the carrier film 5 and the heavy release separator 3 include adhesives, such as acrylic adhesives. The thickness of the adhesive layer formed between the carrier film 5 and the heavy release separator 3 is preferably 0.1 to 10 μm, more preferably 1 to 5 μm.

In this manner, according to the pressure-sensitive adhesive sheet 1 in this embodiment, the separators 3 and 4 and the carrier film 5 can be reliably easily peeled in a predetermined order without peeling failure while the pressure-sensitive adhesive layer 2 is protected.

<Method for Producing Pressure-Sensitive Adhesive Sheet for Image Display Device>

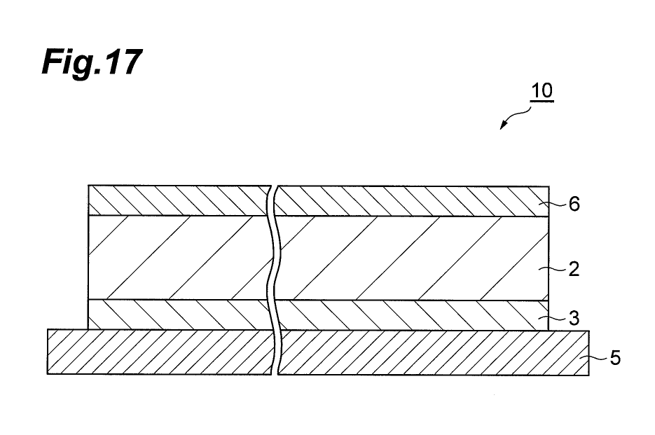

The pressure-sensitive adhesive sheet 1 is produced as follows. First, as shown in FIG. 17, a matrix film 10 in which the heavy release separator 3, the pressure-sensitive adhesive layer 2, and the temporary separator 6 are laminated in order on the carrier film 5 is prepared. The temporary separator 6 is, for example, a layer composed of the same material as that of the light release separator 4.

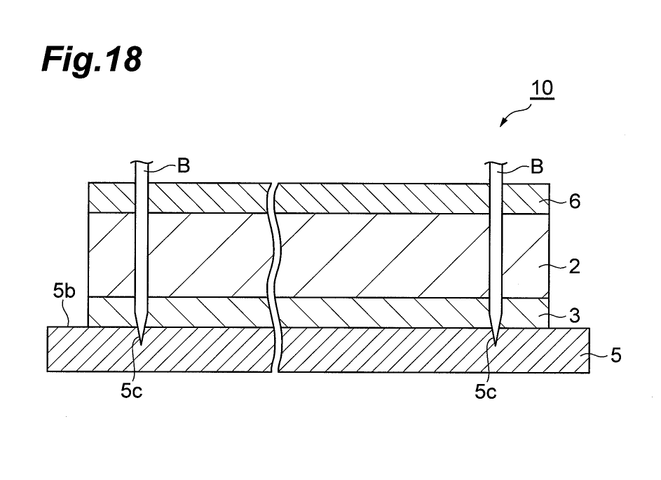

Then, the temporary separator 6, the pressure-sensitive adhesive layer 2, and the heavy release separator 3 are cut into a desired shape by a punching device (not shown) comprising blades B. In this step, it is preferred to pass the blades B through the temporary separator 6, the pressure-sensitive adhesive layer 2, and the heavy release separator 3 at a depth reaching the carrier film 5, as shown in FIG. 18. Thus, cut portions 5c are formed on a surface 5b on the pressure-sensitive adhesive layer 2 side of the carrier film 5. By allowing the blades B to reach the carrier film 5 from the temporary separator 6 in this manner, the pressure-sensitive adhesive layer 2 and the heavy release separator 3 can be completely cut.

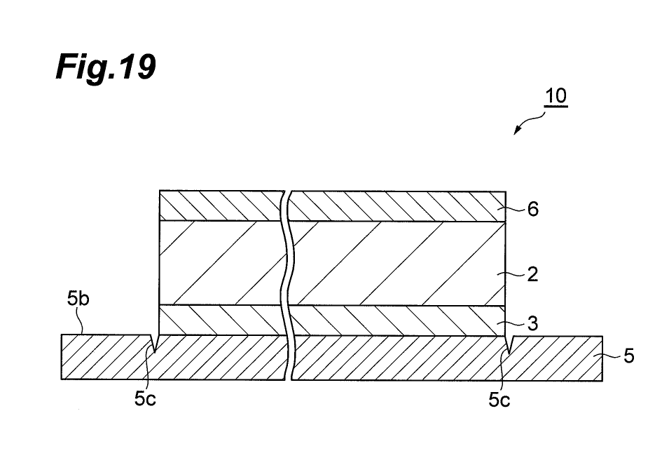

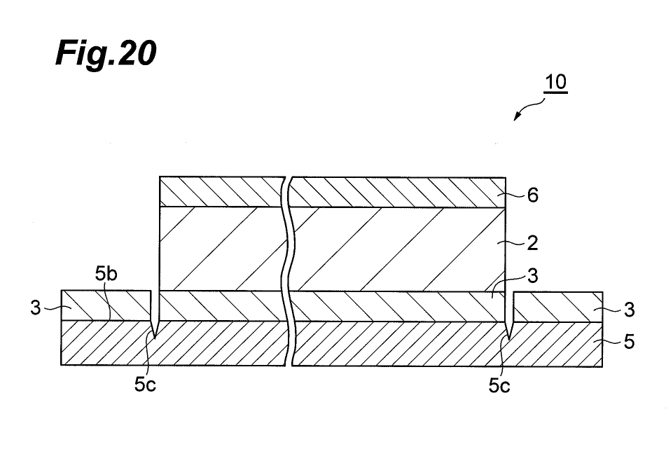

Then, the outer portions of the temporary separator 6, the pressure-sensitive adhesive layer 2, and the heavy release separator 3 are removed as shown in FIG. 19. At this time, it is preferred that the outer edge of the heavy release separator 3 is generally flush with the outer edge of the carrier film 5 as shown in FIG. 20 so that the outer edge of the carrier film 5 does not project more outward than the outer edge of the heavy release separator 3. In other words, it is preferred that only the outer portions of the temporary separator 6 and the pressure-sensitive adhesive layer 2 are removed, the outer portion of the heavy release separator 3 is left on the carrier film 5 without being removed, and the heavy release separator 3 after the cutting is in the state of being attached to the carrier film 5 as it is. Thus, the problem of the exposed portion of the surface 5b on the pressure-sensitive adhesive layer side of the carrier film 5 adhering to other portions can be effectively prevented.

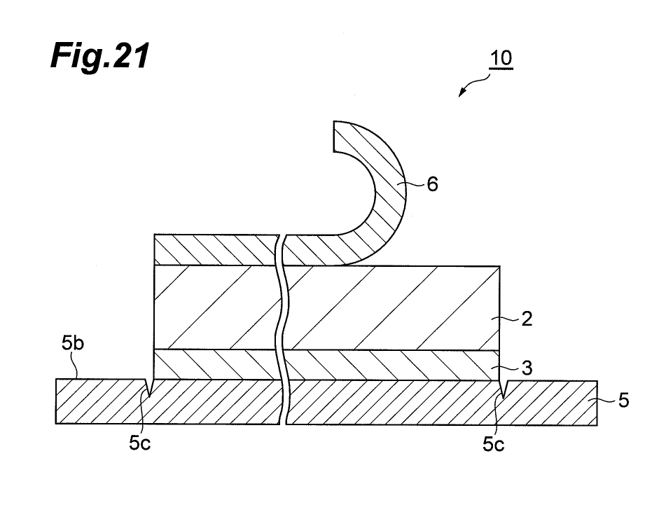

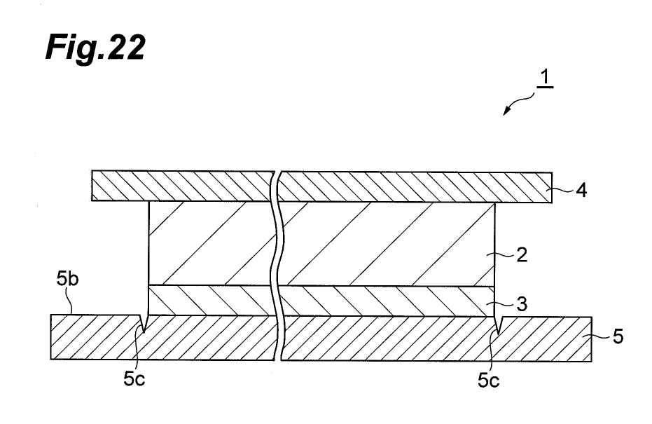

After the outer portions of the temporary separator 6, the pressure-sensitive adhesive layer 2, and the heavy release separator 3 are removed as shown in FIG. 19, then the temporary separator 6 is peeled from the pressure-sensitive adhesive layer 2 as shown in FIG. 21, and the light release separator 4 is affixed to the pressure-sensitive adhesive layer 2 as shown in FIG. 22. The pressure-sensitive adhesive sheet 1 in this embodiment is completed by the above steps. In the film in which the outer edge of the heavy release separator 3 is cut so as to be generally flush with the outer edge of the pressure-sensitive adhesive layer 2 in this manner, difference in the ease of peeling between the light release separator 4 and the heavy release separator 3 is more significant, and therefore, the light release separator 4 can be more easily peeled before the heavy release separator 3 is peeled. Further, since the outer edge of the heavy release separator 3 aligns with the outer edge of the pressure-sensitive adhesive layer 2, the position of the outer edge of the pressure-sensitive adhesive layer 2 is clear, and therefore, the alignment of the pressure-sensitive adhesive layer 2 with an adherend is easy.

<Method for Producing Image Display Device>

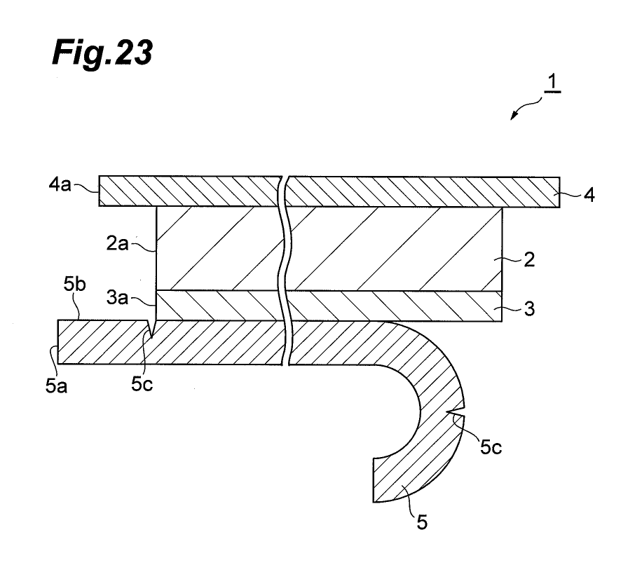

The pressure-sensitive adhesive sheet 1 in this embodiment can be used in a manner similar to that of the pressure-sensitive adhesive sheet in the first embodiment except that the pressure-sensitive adhesive sheet 1 in this embodiment is used after the carrier film 5 is peeled from the heavy release separator 3 first, as shown in FIG. 23.

The preferred embodiments of the present invention have been described above, but the present invention is not necessarily limited to the above embodiments, and various changes can be made without departing from the spirit thereof.

### EXAMPLES

A description of the present invention will be made below by Examples. In the Examples, the pressure-sensitive adhesive sheets according to the first embodiment and the second embodiment are fabricated, but the present invention is not limited to these Examples.

(Synthesis of Acrylic Acid Derivative Polymer (A-1))

84.0 g of 2-ethylhexyl acrylate, 36.0 g of 2-hydroxyethyl acrylate, and 150.0 g of methyl ethyl ketone were added to a reaction container with a cooling tube, a thermometer, a stirring device, a dropping funnel, and a nitrogen introduction tube, and heated from ordinary temperature (25° C.) to 70° C. for 15 minutes while nitrogen replacement was performed at an airflow rate of 100 mL/min, to prepare a solution a.

While the reaction container was kept at 70° C., 21.0 g of 2-ethylhexyl acrylate, 9.0 g of 2-hydroxyethyl acrylate, and 1.0 g of lauroyl peroxide were mixed to prepare a solution b. This solution b was dropped into the solution a over 60 minutes, and after the completion of the dropping, the mixture was further reacted for 2 hours.

Then, the methyl ethyl ketone was distilled off to obtain an acrylic acid derivative polymer (A-1: weight average molecular weight 150000) that was a copolymerized resin of 2-ethylhexyl acrylate and 2-hydroxyethyl acrylate, the above component A.

The weight average molecular weight was determined by measuring using gel permeation chromatography using tetrahydrofuran (THF) as a solvent using the following device and measurement conditions, and converting using the calibration curve of standard polystyrene. In the preparation of the calibration curve, a five sample set (PStQuick MP-H, PStQuick B [trade name, manufactured by Tosoh Corporation]) was used as the standard polystyrene.

Device: high speed GPC device HCL-8320GPC (detector: differential refractometer)

(trade name, manufactured by Tosoh Corporation)

Solvent used: tetrahydrofuran (THF)

Column: column TSKGEL SuperMultipore HZ-H

(trade name, manufactured by Tosoh Corporation)

Column size: Column length is 15 cm, and column inner diameter is 4.6 mm.

Measurement temperature: 40° C.

Flow rate: 0.35 ml/min

Sample concentration: 10 mg/5 ml of THF

Amount of injection: 20 μl

(Synthesis of Polyurethane Diacrylate (PUDA))

303.92 g of polypropylene glycol (molecular weight: 2000), 8.66 g of 2-hydroxyethyl acrylate modified with 2 moles of ε-caprolactone (Placcel FA2D: trade name, Daicel Chemical Industries, Ltd.), 99.74 g of 2-hydroxyethyl acrylate, 0.12 g of p-methoxyphenol, and 0.5 g of dibutyl tin dilaurate were added to a reaction container with a cooling tube, a thermometer, a stirring device, a dropping funnel, and an air injection tube, and heated to 75° C. while air was flowed, and further, 36.41 g of isophorone diisocyanate was uniformly dropped over 2 hours with stirring at 75° C. to perform a reaction.

When the reaction liquid was reacted for 5 hours after the completion of the dropping, 44.88 g of 2-hydroxyethyl acrylate was further added to the reaction liquid, and the reaction liquid was reacted for 1 hour. As a result of IR measurement, it was confirmed that the isocyanate disappeared, and the reaction was completed. Thus, a polyurethane diacrylate (PUDA: weight average molecular weight 20000) having polypropylene glycol and isophorone diisocyanate as repeating units and having a polymerizable unsaturated bond was obtained.

The following components that were raw materials of a pressure-sensitive adhesive resin composition were prepared.

Component A: the acrylic acid derivative polymer (A-1)
Component B: acryloylmorpholine (ACMO)

: 2-ethylhexyl acrylate (EHA)

Component C: polypropylene glycol diacrylate (FA-P240A: “FANCRYL FA-P240A” manufactured by Hitachi Chemical Co., Ltd., represented by formula (e), the average value of n is 7)

: a polyurethane diacrylate (PUDA: a crosslinking agent having a bifunctional (meth)acryloyl group)

Component D: 1-hydroxycyclohexyl phenyl ketone (1-184: manufactured by BASF)

### Example 1

### Fabrication of Pressure-Sensitive Adhesive Sheet 1 (Three-Layer Article)

A pressure-sensitive adhesive sheet 1 was fabricated in the following procedures (I) to (VI) using polyethylene terephthalate having a thickness of 75 μm (manufactured by FUJIMORI KOGYO CO., LTD.) as a heavy release separator 3 and polyethylene terephthalate having a thickness of 50 μm (manufactured by FUJIMORI KOGYO CO., LTD.) as a light release separator 4 and a temporary separator 6.

(I) 35 g of the acrylic acid derivative polymer (A-1), 35.5 g of 2-ethylhexyl acrylate (EHA), 22 g of acryloylmorpholine (ACMO), 7 g of the polyurethane diacrylate (PUDA), and 0.5 g of 1-hydroxycyclohexyl phenyl ketone (1-184) were weighed, and these were stirred and mixed to obtain a pressure-sensitive adhesive resin composition that was liquid at ordinary temperature.

(II) This pressure-sensitive adhesive resin composition was applied to the heavy release separator 3 to form a coating film, then the temporary separator 6 was laminated on the pressure-sensitive adhesive layer 2, and the laminate was irradiated with ultraviolet rays (200 mJ/cm²) to obtain a pressure-sensitive adhesive sheet in which the pressure-sensitive adhesive layer 2 was sandwiched between the heavy release separator 3 and the temporary separator 6. The application was performed with the thickness of the pressure-sensitive adhesive layer 2 adjusted to 250 μm.

(III) The heavy release separator 3, the pressure-sensitive adhesive layer 2, and the temporary separator 6 were cut to 220 mm×180 mm by rotary blades having a diameter of 72 mm.

(IV) The pressure-sensitive adhesive layer 2 and the temporary separator 6 were cut to 205 mm×160 mm by rotary blades having a diameter of 72 mm. At this time, cutting was performed so that both sides on the long side sides of the heavy release separator 3 projected more than both sides on the long side sides of the pressure-sensitive adhesive layer 2 by 7.5 mm, and both sides on the short side sides of the heavy release separator 3 projected more than both sides on the short side sides of the pressure-sensitive adhesive layer 2 by 5 mm. In the cutting in (III) and (IV), a rotary punching device was used.

(V) The temporary separator 6 was peeled, and the 215 mm×170 mm light release separator 4 was laminated on the pressure-sensitive adhesive layer 2. In this manner, the pressure-sensitive adhesive sheet 1 was obtained. At this time, lamination was performed so that both sides on the long side sides of the light release separator 4 projected more than both sides on the long side sides of the pressure-sensitive adhesive layer 2 by 5 mm, and both sides on the short side sides of the light release separator 4 projected more than both sides on the short side sides of the pressure-sensitive adhesive layer 2 by 5 mm.

### Examples 2 to 6 and Comparative Examples 1 to 2

Pressure-sensitive adhesive sheets 1 were obtained as in Example 1 except that blending conditions and the amount of exposure were as shown in Table 1 and Table 2.

[Various Evaluations]

For the pressure-sensitive adhesive sheets obtained in the Examples and the Comparative Examples, the following evaluations (1) to (6) were performed.

(1) Measurement of Glass Transition Temperature (Tg), Shear Storage Modulus, Loss Modulus, and tan δ

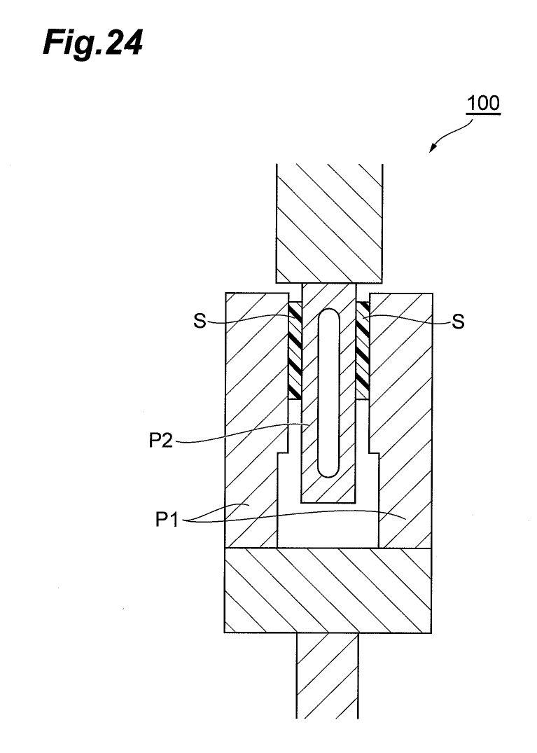

Two pressure-sensitive adhesive layers having a thickness of 250 jam were superimposed to a thickness of about 500 μm, and cut to a width of 10 mm and a length of 10 mm to fabricate a sample. Two of the above samples were prepared, and the samples S were sandwiched between plates P1 at both ends and a plate P2 at a center using a jig 100, as shown in FIG. 24, to provide measurement samples. Then, the glass transition temperature (Tg), shear storage modulus, loss modulus, and tan δ of the samples were measured using a wide area dynamic viscoelasticity measuring device (Solids Analyzer RSA-II manufactured by Rheometric Scientific). Measurement conditions were “shear sandwich mode, frequency: 1.0 Hz, measurement temperature range: −20 to 100° C., heating rate: 5° C./min.”

(2) Step Height Covering Properties Evaluation

Each of the pressure-sensitive adhesive sheets obtained in the Examples and the Comparative Examples was cut to the size of a width of 50 mm and a length of 80 mm. Then, the light release separator 4 was peeled, and the pressure-sensitive adhesive layer was bonded to a 58 mm×86 mm×0.7 mm (thickness) glass substrate A using a roller.

Then, the heavy release separator 3 was peeled. Then, a glass substrate B having a step in which an outer peripheral portion was printed to a thickness of 60 μm (step: 60 μm) was bonded to the other pressure-sensitive adhesive layer side to which the glass substrate A was not bonded, using a laminator device. Then, autoclave treatment (60° C., 0.5 MPa) was performed for 30 minutes, and an evaluation was performed according to the following criteria. The glass substrate B having a step in which an outer peripheral portion is printed has the same outer dimensions as the glass substrate A, and has an opening having inner dimensions of 45 mm×68 mm. The evaluation of filling-up properties was performed using the above glass substrate B instead of an input device or an image display device.

(Evaluation Criteria)

The presence or absence of bubbles in the vicinity of a joining portion between the inner peripheral wall of the step and the glass substrate (four sides that the opening had) was checked.

A: There are no bubbles, or bubbles remain only on one side.
B: Bubbles remain on two sides.
C: Bubbles remain on three or more sides.

(3) Cutting Properties Evaluation

In the step of cutting in (III), an evaluation was performed according to the following criteria.

(Evaluation Criteria)

A: The heavy release separator 3, the pressure-sensitive adhesive layer 2, and the temporary separator 6 can be easily cut into a desired shape.
B: The pressure-sensitive adhesive layer sticks to the rotary blades and workability decreases, or the heavy release separator 3, the pressure-sensitive adhesive layer 2, and the temporary separator 6 cannot be cut into a desired shape.

(4) Measurement of Peel Strength

Each of the pressure-sensitive adhesive sheets obtained in the Examples and the Comparative Examples was cut to the size of a width of 10 mm and a length of 50 mm. Then, the light release separator 4 was peeled, and the pressure-sensitive adhesive layer 2 was affixed to a glass substrate (soda lime glass) or an acrylic resin substrate (hereinafter sometimes referred to as an “acrylic substrate”), and then, the laminate was irradiated with ultraviolet rays at 2000 mJ/cm² from each substrate side by an ultraviolet irradiation device. Then, the heavy release separator 3 was peeled, and peel strength between the pressure-sensitive adhesive layer 2 and each substrate when the pressure-sensitive adhesive layer 2 was 180 degree-peeled using a tensile tester (“RTC-1210” manufactured by ORIENTEC CO., LTD.) was measured. Measurement was performed with measurement conditions being peeling at a peel rate of 300 mm/min for 3 seconds and measurement temperature being 25° C.

(5) Appearance Evaluation

Each of the pressure-sensitive adhesive sheets obtained in the Examples and the Comparative Examples was cut to the size of a width of 50 mm and a length of 100 mm. Then, the light release separator 4 was peeled, and the pressure-sensitive adhesive layer 2 was affixed to a glass substrate having dimensions of 50 mm×100 mm×0.7 mm (thickness) at 25° C. under atmospheric pressure with a load of 500 g using a rubber roller (roller diameter: 50 mm, roller width: 210 mm).

Then, the heavy release separator 3 was peeled, and a glass substrate having dimensions of 50 mm×100 mm×0.7 mm (thickness), having a step printed on an outer peripheral portion, (step: 60 μm, having an opening having inner dimensions of 45 mm×68 mm), or an acrylic resin substrate having dimensions of 50 mm×100 mm×1.5 mm (thickness), having a step printed on an outer peripheral portion, (step: 60 μm, having an opening having inner dimensions of 45 mm×68 mm) was bonded to the pressure-sensitive adhesive layer 2 using a rubber roller. Then, the following two types of structures were fabricated.

Structure 1: a structure in which a pressure-sensitive adhesive layer is sandwiched between a glass substrate and a glass substrate

Structure 2: a structure in which a pressure-sensitive adhesive layer is sandwiched between a glass substrate and an acrylic resin substrate

Then, autoclave treatment (60° C., 0.5 MPa, 30 minutes) was performed on each structure, and the structure was further irradiated with ultraviolet rays at 2000 mJ/cm² from the side of the glass substrate having no step, using an ultraviolet irradiation device, to provide an evaluation sample.

The following tests were performed on the evaluation sample, and an appearance evaluation (the evaluation of the presence or absence of bubbles in the pressure-sensitive adhesive layer 2, and the presence or absence of the stripping of the substrate) after the sample was removed from a tester was visually performed.

High temperature and high humidity test (described as “85° C./85% RH” in the Tables): The evaluation sample was allowed to stand under the conditions of 85° C. and 85% RH for 24 hours.

High temperature test (described as “100° C.” in the Tables): The evaluation sample was allowed to stand under the conditions of 100° C. for 24 hours.

Thermal cycle test (described as “TCT” in the Tables): Heat cycles (100 times) in which the evaluation sample was allowed to stand in an atmosphere of −40° C. for 30 minutes and allowed to stand in an atmosphere of 100° C. for 30 minutes were performed.

(Evaluation Criteria)

A: There is no peeling or the generation of bubbles.
B: There is no peeling, and the number of bubbles is 1 or more and less than 5.
C: 5 or more bubbles are generated.

Bubbles were visually observed by a 5-power loupe, and a bubble in which diameter was about 10 μm or more was counted as 1.

(6) Whether or Not Pressure-sensitive Adhesive Sheet Can Be Fabricated

One in which the pressure-sensitive adhesive layer 2 could be cut well and a pressure-sensitive adhesive sheet having a desired shape could be fabricated was evaluated as A, and one in which a pressure-sensitive adhesive sheet having a desired shape could not be fabricated was evaluated as B.

The evaluation results of the Examples and the Comparative Examples are shown in Table 1 and Table 2.

TABLE 1

| | | | | | | |
|---|---|---|---|---|---|---|
| | Exam- | Exam- | Exam- | Exam- | Exam- | Exam- |
| Items | ple 1 | ple 2 | ple 3 | ple 4 | ple 5 | ple 6 |

Pressure-sensitive adhesive layer
Blending conditions

| | | | | | | | |
|---|---|---|---|---|---|---|---|
| A-1 | Amount | 35 | 35 | 35 | 35 | 30 | 35 |
| EHA | blended | 35.5 | 35.5 | 35.5 | 37.5 | 40.5 | 30.8 |
| ACMO | (g) | 22 | 22 | 22 | 22 | 22 | 27 |
| FA- | | 0 | 0 | 0 | 5 | 0 | 0 |
| P240A | | | | | | | |
| PUDA | | 7 | 7 | 7 | 0 | 7 | 7 |
| I-184 | | 0.5 | 0.5 | 0.5 | 0.5 | 0.5 | 0.2 |

| | | | | | | |
|---|---|---|---|---|---|---|
| Film thickness | 250 | 250 | 250 | 250 | 250 | 250 |
| (μm) | | | | | | |
| Amount of | 200 | 300 | 500 | 300 | 350 | 500 |
| exposure | | | | | | |
| (mJ/cm²) | | | | | | |

Various evaluations
Dynamic viscoelasticity evaluation

| | | | | | | |
|---|---|---|---|---|---|---|
| Tg (° C.) | −23 | −16 | −7 | −14 | −7 | −6 |
| tan δ | 0.57 | 0.65 | 0.63 | 0.71 | 0.54 | 0.63 |
| (−20-25° C.) | | | | | | |
| Shear storage | 39 | 49 | 92 | 102 | 42 | 73 |
| modulus | | | | | | |
| (25° C.) (kPa) | | | | | | |
| Step height | A | A | A | A | A | A |
| covering | | | | | | |
| properties | | | | | | |
| Cutting | A | A | A | A | A | A |
| properties | | | | | | |

Peel strength

| | | | | | | |
|---|---|---|---|---|---|---|
| Glass substrate | 15 | 13.6 | 14.2 | 14.2 | 13.6 | 14.4 |
| (25° C.) | | | | | | |
| (N/10 mm) | | | | | | |
| Acrylic substrate | 16.1 | 15.8 | 16.3 | 14.9 | 16.1 | 15.2 |
| (25° C.) | | | | | | |
| (N/10 mm) | | | | | | |

Appearance

| | | | | | | | |
|---|---|---|---|---|---|---|---|
| Struc- | 85° C./ | A | A | A | A | A | A |
| ture | 85% RH | | | | | | |
| 1 | 100° C. | A | A | A | A | A | A |
| | TCT | A | A | A | A | A | A |
| Struc- | 85° C./ | A | A | A | A | A | A |
| ture | 85% RH | | | | | | |
| 2 | 100° C. | A | A | A | A | A | A |
| | TCT | A | A | A | A | A | A |

| | | | | | | |
|---|---|---|---|---|---|---|
| Whether or not | A | A | A | A | A | A |
| pressure-sensitive | | | | | | |
| adhesive sheet | | | | | | |
| can be fabricated | | | | | | |

TABLE 2

| | | |
|---|---|---|
| | Comparative | Comparative |
| Items | Example 1 | Example 2 |

Pressure-sensitive adhesive layer
Blending conditions

| | | | |
|---|---|---|---|
| A-1 | Amount | 35 | 35 |
| EHA | blended | 35.5 | 35.5 |
| ACMO | (g) | 22 | 22 |
| FA-P240A | | 0 | 0 |
| PUDA | | 7 | 7 |
| I-184 | | 0.5 | 0.5 |

| | | |
|---|---|---|
| Film thickness (μm) | 250 | 250 |
| Amount of exposure (mJ/cm²) | 700 | 150 |

Various evaluations
Dynamic viscoelasticity evaluation

| | | |
|---|---|---|
| Tg (° C.) | 8 | −25 |
| tan δ (−20-25° C.) | 0.14 | 0.51 |
| Shear storage modulus | 177 | 19 |
| (25° C.) (kPa) | | |
| Step height covering | C | A |
| properties | | |
| Cutting properties | A | B |

Peel strength

| | | |
|---|---|---|
| Glass substrate | 14.7 | 3.8 |
| (25° C.) (N/10 mm) | | |
| Acrylic substrate | 16.1 | 4.2 |
| (25° C.) (N/10 mm) | | |

Appearance

| | | | |
|---|---|---|---|
| Structure 1 | 85° C./85% RH | B | A |
| | 100° C. | B | A |
| | TCT | B | A |
| Structure 2 | 85° C./85% RH | C | B |
| | 100° C. | C | B |
| | TCT | C | B |

| | | |
|---|---|---|
| Whether or not pressure- | A | B |
| sensitive adhesive sheet can | | |
| be fabricated | | |

### Example 7

### Fabrication of Pressure-Sensitive Adhesive Sheet 2 (Four-Layer Article)

(I) A liquid pressure-sensitive adhesive resin composition was obtained by a method similar to that of Example 1.
(II) This pressure-sensitive adhesive resin composition was applied to one surface of a heavy release separator 3 to form a coating film, then a temporary separator 6 was laminated on the pressure-sensitive adhesive layer 2, the laminate was irradiated with ultraviolet rays (200 mJ/cm²), then an acrylic adhesive (HITALEX K-6040 (trade name), manufactured by Hitachi Chemical Co., Ltd.) was further laminated on the other surface of the heavy release separator 3, and a carrier film 5 was laminated on the acrylic adhesive.
(III) The heavy release separator 3, the pressure-sensitive adhesive layer 2, the temporary separator 6, and the carrier film 5 were cut to 220 mm×180 mm.
(IV) The pressure-sensitive adhesive layer 2, the heavy release separator 3, and the temporary separator 6 were cut to 205 mm×160 mm by rotary blades having a diameter of 72 mm. A rotary punching device was used for the cutting. At this time, cutting was performed so that both sides on the long side sides of the carrier film 5 projected more than both sides on the long side sides of the pressure-sensitive adhesive layer 2 by 7.5 mm, and both sides on the short side sides of the carrier film 5 projected more than both sides on the short side sides of the pressure-sensitive adhesive layer 2 by 5 mm.
(V) The temporary separator 6 was peeled, and a 215 mm×170 mm light release separator 4 was laminated on the pressure-sensitive adhesive layer 2. In this manner, a pressure-sensitive adhesive sheet 2 was obtained. At this time, lamination was performed so that both sides on the long side sides of the light release separator 4 projected more than both sides on the long side sides of the pressure-sensitive adhesive layer 2 by 5 mm, and both sides on the short side sides of the light release separator 4 projected more than both sides on the short side sides of the pressure-sensitive adhesive layer 2 by 5 mm.

When evaluations similar to the above were performed for the pressure-sensitive adhesive sheet 2, results were that a pressure-sensitive adhesive sheet having a desired shape could be fabricated, and the pressure-sensitive adhesive sheet 2 was excellent in all of step height covering properties, cutting properties, and appearance as in Example 1.

According to the present invention, a pressure-sensitive adhesive sheet for an image display device, comprising a pressure-sensitive adhesive layer excellent in transparency, handling properties, step height covering properties, and cutting properties, can be produced. In addition, by promoting the crosslinking reaction of the pressure-sensitive adhesive layer after bonding base materials or the like, the close adhesive force and holding force of the pressure-sensitive adhesive layer itself can be improved. A device in which such a pressure-sensitive adhesive layer is incorporated shows high reliability, and therefore, the pressure-sensitive adhesive sheet of the present invention is suited to image display device applications. Particularly, the pressure-sensitive adhesive sheet of the present invention is extremely useful as a sheet material used when filling between an information input device, such as a touch panel, and a transparent protective plate.

### REFERENCE SIGNS LIST

1: pressure-sensitive adhesive sheet, 2: pressure-sensitive adhesive layer, 3: heavy release separator, 4: light release separator, 5: carrier film, 6: temporary separator, 2a, 3a, 4a, 5a: outer edge, 3b: a surface on a pressure-sensitive adhesive layer side, 3c: cut portion, 10: matrix film, B: blade, 40: transparent protective plate (glass or plastic substrate), 7: image display unit, 12: liquid crystal display cell, 20, 22: polarizing plate, 30: touch panel, 31, 32: transparent resin layer, 50: backlight system, 60: step, 100: jig.

What is claimed is:

1. A pressure-sensitive adhesive sheet for an image display device, comprising a pressure-sensitive adhesive layer and a pair of base material layers laminated so as to sandwich the pressure-sensitive adhesive layer, wherein
outer edges of the base material layers project more outward than an outer edge of the pressure-sensitive adhesive layer, and
the pressure-sensitive adhesive layer is formed from a pressure-sensitive adhesive resin composition comprising a structural unit derived from an alkyl (meth)acrylate in which a number of carbon atoms of an alkyl group is 4 to 18, and has a shear storage modulus at 25° C. of 30 to 150 kPa.

2. A pressure-sensitive adhesive sheet for an image display device, comprising a pressure-sensitive adhesive layer, first and second base material layers laminated so as to sandwich the pressure-sensitive adhesive layer, and a carrier layer further laminated on the second base material layer, wherein outer edges of the first base material layer and the carrier layer project more outward than an outer edge of the pressure-sensitive adhesive layer, and
the pressure-sensitive adhesive layer is formed from a pressure-sensitive adhesive resin composition comprising a structural unit derived from an alkyl (meth)acrylate in which a number of carbon atoms of an alkyl group is 4 to 18, and has a shear storage modulus at 25° C. of 30 to 150 kPa.

3. A method for producing an image display device, comprising:
a step of bonding adherends to each other via the pressure-sensitive adhesive layer that the pressure-sensitive adhesive sheet for an image display device according to claim 1 comprises, to obtain a laminate;
a step of subjecting the laminate to heating and pressurization treatment under conditions of 40 to 80° C. and 0.3 to 0.8 MPa; and
a step of irradiating the laminate with ultraviolet rays from a side of either one of the adherends.

4. A method for producing an image display device, comprising:
a step of bonding adherends to each other via the pressure-sensitive adhesive layer that the pressure-sensitive adhesive sheet for an image display device according to claim 2 comprises, to obtain a laminate;
a step of subjecting the laminate to heating and pressurization treatment under conditions of 40 to 80° C. and 0.3 to 0.8 MPa; and
a step of irradiating the laminate with ultraviolet rays from a side of either one of the adherends.

5. The method according to claim 3, wherein the adherends are a transparent protective plate and a touch panel.

6. The method according to claim 4, wherein the adherends are a transparent protective plate and a touch panel.

7. An image display device produced by the method according to claim 3.

8. An image display device produced by the method according to claim 4.
